(19) United States
(12) Patent Application Publication
(10) Pub. No.: US 2013/0083766 A1
(43) Pub. Date: Apr. 4, 2013

(54) METHOD AND DEVICE FOR TRANSMITTING AND RECEIVING UPLINK CONTROL INFORMATION IN WIRELESS COMMUNICATION SYSTEM THAT SUPPORTS MULTIPLE CARRIERS

(71) Applicants: Jae-hoon Chung, Anyang-si (KR); Moonil Lee, Anyang-si (KR); Seunghee Han, Anyang-si (KR); Hyunsoo Ko, Anyang-si (KR)

(72) Inventors: Jae-hoon Chung, Anyang-si (KR); Moonil Lee, Anyang-si (KR); Seunghee Han, Anyang-si (KR); Hyunsoo Ko, Anyang-si (KR)

(73) Assignee: LG ELECTRONICS INC., Seoul (KR)

(21) Appl. No.: 13/702,486

(22) PCT Filed: Jun. 22, 2011
(86) PCT No.: PCT/KR2011/004558

§ 371 Date: Dec. 6, 2012

Related U.S. Application Data
(60) Provisional application No. 61/357,102, filed on Jun. 22, 2010.

(51) Int. Cl. H04W 72/04

(52) U.S. Cl. CPC H04W 72/0413
USPC 370/329

(57) ABSTRACT

The present invention relates to a wireless communication system, and more specifically, to a method and a device for transmitting and receiving uplink control information in a wireless communication system that supports multiple carriers. According to one embodiment of the present invention, a method for allowing a terminal to transmit uplink control information (UCI) in a wireless communication system that supports multiple carriers comprises the steps of: receiving one or more uplink grants from a base station; obtaining an indicator which indicates an uplink carrier on which said UCI is transmitted from each of the one or more uplink grants; and transmitting said UCI through a physical uplink shared channel (PUSCH) on the uplink carrier indicated by said indicator, if the one or more uplink grants schedule uplink data transmission on the uplink carrier indicated by said indicator.

### TECHNICAL FIELD

The present invention relates to a wireless communication system, and more particularly, to a method and apparatus for transmitting and receiving uplink control information in a wireless communication system that supports multiple carriers.

### BACKGROUND ART

In a general wireless communication system, typically, a single carrier is considered in uplink and downlink although different bandwidths are set for uplink and downlink. For example, it is possible to provide a wireless communication system based on a single carrier in which the number of carriers constituting each of the uplink and the downlink is 1 and bandwidths of the uplink and the downlink are symmetrical to each other.

It is required for an advanced wireless communication system to support a bandwidth extended compared to a conventional wireless communication system. However, it is difficult to allocate frequencies of a large bandwidth throughout the world, except for some regions. Thus, as a technology for efficiently using small fragmented bands, a carrier aggregation technology which is also referred to as bandwidth aggregation or spectrum aggregation has been developed to allow a number of physical bands to be combined in the frequency domain to be used as a large logical band. Here, each of the aggregated carriers may be referred to as a Component Carrier (CC) or a cell. Carrier aggregation may be applied to each of the uplink and downlink.

Multiple-Input Multiple-Output (MIMO) is a method for improving data transmission and reception efficiency using multiple transmit antennas and multiple receive antennas. That is, MIMO is a technology for increasing capacity or improving performance using multiple antennas at the transmitting side and/or receiving side. The MIMO technology may also be referred to as a multi-antenna technology. In order for the transmitting side to correctly perform multi-antenna transmission, it is required that the receiving side feed channel information back to the transmitting side. Such feedback information may include a Rank Indicator (RI) of a downlink channel, a Precoding Matrix Index (PMI), and Channel Status Information (CSI) such as Channel Quality Information (CQI).

Hybrid Automatic Repeat and reQuest Acknowledgement/Negative-ACK (HARQ ACK/NACK) information indicating whether or not downlink data has been successfully decoded may be transmitted from a user equipment to a base station. The user equipment may also transmit, to the base station, Scheduling Request (SR) information for requesting that the base station provide scheduling information for uplink transmission.

Such control information including CSI, a HARQ ACK/NACK, and an SR may be collectively referred to as Uplink Control Information (UCI). The UCI may be transmitted through a Physical Uplink Control Channel (PUCCH) or a Physical Uplink Shared Channel (PUSCH). When the UCI is transmitted through a PUSCH, the UCI and uplink data may be multiplexed and transmitted.

### DISCLOSURE

### Technical Problem

For the conventional wireless communication system which supports only a single carrier in uplink, there is no need to define which carrier is to be used to transmit Uplink Control Information (UCI). However, in a system that supports multiple carriers in uplink, there may be ambiguity as to an uplink carrier through which an uplink transmission entity is to transmit UCI and an uplink carrier through which an uplink reception entity is to receive UCI. For example, an uplink reception entity (for example, a base station) may provide an uplink transmission entity (for example, a user equipment) with information for scheduling uplink transmission (which is referred to as a uplink grant (UL grant). In a multi-carrier environment, it is possible to indicate an uplink carrier through which uplink transmission is to be performed through the UL grant. The user equipment may fail to detect the UL grant. In this case, there may be ambiguity as to an uplink carrier through which the user equipment is to transmit UCI. In addition, if the user equipment transmits the UCI through a carrier different from that through which the base station expects the UCI to be transmitted while the base station fails to determine that the user equipment has failed to detect the UL grant, there is ambiguity as to an uplink carrier through which the base station is to receive the UCI.

The present invention has been made to overcome such a problem and it is an object of the present invention to provide a method for reducing ambiguity as to which uplink carrier is to be used to transmit or receive UCI in a multi-carrier environment.

Objects of the present invention are not limited to those described above and other objects will be clearly understood by those skilled in the art from the following description.

### Technical Solution

A method for a user equipment to transmit Uplink Control Information (UCI) in a wireless communication system that supports multiple carriers according to an embodiment of the present invention in order to achieve the above objects may include receiving at least one uplink grant from a base station, acquiring an indicator which indicates an uplink carrier in which the UCI is transmitted from each of the at least one uplink grant, and transmitting the UCI through a Physical Uplink Shared Channel (PUSCH) in the uplink carrier indicated by the indicator when the at least one uplink grant schedules uplink data transmission in the uplink carrier indicated by the indicator.

A method for a base station to receive Uplink Control Information (UCI) in a wireless communication system that supports multiple carriers according to another embodiment of the present invention in order to achieve the above objects may include transmitting at least one uplink grant, each including an indicator which indicates an uplink carrier in which the UCI is transmitted, to a user equipment, and attempting to detect the UCI that is transmitted through a Physical Uplink Shared Channel (PUSCH) in the uplink carrier indicated by the indicator. Here, the UCI may be transmitted through a PUSCH in an uplink carrier indicated by the indicator when an uplink grant detected by the user equipment schedules uplink data transmission in the uplink carrier indicated by the indicator.

A user equipment for transmitting Uplink Control Information (UCI) in a wireless communication system that supports multiple carriers according to another embodiment of the present invention in order to achieve the above objects may include a reception module for receiving a downlink signal, a transmission module for transmitting an uplink signal, and a processor connected to the reception module and the transmission module, the processor controlling operation of the user equipment. Here, the processor may be configured to receive at least one uplink grant from a base station through the reception module, to acquire an indicator which indicates an uplink carrier in which the UCI is transmitted from each of the at least one uplink grant, and to transmit the UCI through a Physical Uplink Shared Channel (PUSCH) in the uplink carrier indicated by the indicator through the transmission module when the at least one uplink grant schedules uplink data transmission in the uplink carrier indicated by the indicator.

A base station for receiving Uplink Control Information (UCI) in a wireless communication system that supports multiple carriers according to another embodiment of the present invention in order to achieve the above objects may include a reception module for receiving a downlink signal, a transmission module for transmitting an uplink signal, and a processor connected to the reception module and the transmission module, the processor controlling operation of the base station. Here, the processor may be configured to transmit at least one uplink grant, each including an indicator which indicates an uplink carrier in which the UCI is transmitted, to a user equipment through the transmission module and to attempt to detect the UCI that is transmitted through a Physical Uplink Shared Channel (PUSCH) in the uplink carrier indicated by the indicator. Here, the UCI may be transmitted through a PUSCH in an uplink carrier indicated by the indicator when an uplink grant detected by the user equipment schedules uplink data transmission in the uplink carrier indicated by the indicator.

The following features may be commonly applied to the above embodiments of the present invention.

When data is present in a transmission buffer of the user equipment, the UCI may be multiplexed and transmitted with the uplink data through the PUSCH and, when no data is present in the transmission buffer of the user equipment, the UCI may be transmitted without data through the PUSCH.

The UCI may be transmitted through a Physical Uplink Control Channel (PUCCH) of a specific uplink carrier when the at least one uplink grant does not schedule uplink data transmission in the uplink carrier indicated by the indicator. In the meantime, the base station may attempt to detect the UCI transmitted through a Physical Uplink Control Channel (PUCCH) of a specific uplink carrier. Here, the specific uplink carrier may be an uplink primary carrier.

If the at least one uplink grant schedules uplink data transmission in a specific uplink carrier indicated by the indicator when the base station has instructed that simultaneous transmission of a Physical Uplink Control Channel (PUCCH) and a Physical Uplink Shared Channel (PUSCH) be allowed in a user equipment specific manner or in a cell specific manner, the uplink data may be transmitted through a PUSCH in the specific uplink carrier and the UCI may be transmitted through a PUCCH in the specific uplink carrier simultaneously with transmission of the uplink data while the base station may attempt to detect the UCI transmitted through a Physical Uplink Control Channel (PUCCH) of a specific uplink carrier. Here, the specific uplink carrier may be an uplink primary carrier.

A value of the indicator may be set equal in the at least one uplink grant.

The at least one uplink grant may include control information for scheduling uplink data transmission in one uplink subframe.

It is to be understood that both the foregoing general description and the following detailed description of the present invention are exemplary and explanatory and are intended to provide further explanation of the invention as claimed.

### Advantageous Effects

According to the present invention, it is possible to provide a method in which ambiguity as to an uplink carrier through which the user equipment is to transmit UCI can be reduced even when the user equipment has missed an uplink grant in a system which supports multiple carriers, thereby reducing the complexity of a UCI detection operation of the base station.

Advantages of the present invention are not limited to those described above and other advantages will be clearly understood by those skilled in the art from the following description.

### DESCRIPTION OF DRAWINGS

The drawings, which are attached to this specification to provide a further understanding of the invention, illustrate various embodiments of the invention and together with the description serve to explain the principle of the invention.

FIG. 1 illustrates the structure of a radio frame used in a 3GPP LTE system.

FIG. 2 illustrates a resource grid in a downlink slot.

FIG. 3 illustrates the structure of a downlink subframe.

FIG. 4 illustrates the structure of an uplink subframe.

FIG. 5 illustrates the configurations of a physical layer and a MAC layer of a system that supports multiple carriers.

FIG. 6 conceptually illustrates component carriers for downlink and uplink.

FIG. 7 illustrates exemplary setting of a linkage between downlink and uplink carriers.

FIG. 8 illustrates a structure of resource mapping of a Physical Uplink Control Channel (PUCCH) in an uplink physical resource block.

FIG. 9 illustrates a method in which uplink data and uplink control information are mapped to physical resources of a Physical Uplink Shared Channel (PUSCH).

FIG. 10 illustrates the case in which cross-carrier scheduling is not applied.

FIG. 11 illustrates the case in which cross-carrier scheduling is applied.

FIG. 12 illustrates an example in which a PUSCH on which uplink control information is to be transmitted through piggyback is selected according to an instruction provided through an uplink grant.

FIG. 13 illustrates an example in which a PUSCH of a carrier having the lowest index is selected as a PUSCH on which uplink control information is to be transmitted through piggyback.

FIGS. 14 to 20 illustrate examples in which a PUSCH on which uplink control information is piggybacked is determined using an Uplink Grant Counter (UGC).

FIGS. 21 to 27 illustrate examples in which a PUSCH on which uplink control information is piggybacked is determined using a UCI Piggybacking Indicator (UPI).

FIG. 28 is a flowchart illustrating a method for transmitting and receiving uplink control information according to the present invention.

FIG. 29 illustrates the configurations of an eNB and a UE according to the present invention.

### BEST MODE

The embodiments described below are provided by combining components and features of the present invention in specific forms. The components or features of the present invention can be considered optional unless explicitly stated otherwise. The components or features may be implemented without being combined with other components or features. The embodiments of the present invention may also be provided by combining some of the components and/or features. The order of the operations described below in the embodiments of the present invention may be changed. Some components or features of one embodiment may be included in another embodiment or may be replaced with corresponding components or features of another embodiment.

The embodiments of the present invention have been described focusing mainly on the data communication relationship between a terminal and a Base Station (BS). The BS is a terminal node in a network which performs communication directly with the terminal. Specific operations which have been described as being performed by the BS may also be performed by an upper node as needed.

That is, it will be apparent to those skilled in the art that the BS or any other network node may perform various operations for communication with terminals in a network including a number of network nodes including BSs. Here, the term “base station (BS)” may be replaced with another term such as “fixed station”, “Node B”, “eNode B (eNB)”, or “access point”. The BS (eNB) described in this disclosure conceptually includes a cell or sector. The term “relay” may be replaced with another term such as “Relay Node (RN)” or “Relay Station (RS)”. The term “terminal” may be replaced with another term such as “User Equipment (UE)”, “Mobile Station (MS)”, “Mobile Subscriber Station (MSS)”, or “Subscriber Station (SS)”.

Specific terms used in the following description are provided for better understanding of the present invention and can be replaced with other terms without departing from the spirit of the present invention.

In some instances, known structures and devices are omitted or shown in block diagram form, focusing on important features of the structures and devices, so as not to obscure the concept of the present invention. The same reference numbers will be used throughout this specification to refer to the same or like parts.

The embodiments of the present invention can be supported by standard documents of at least one of the IEEE 802 system, the 3GPP system, the 3GPP LTE system, the LTE-Advanced (LTE-A) system, and the 3GPP2 system which are wireless access systems. That is, steps or portions that are not described in the embodiments of the present invention for the sake of clearly describing the spirit of the present invention can be supported by the standard documents. For all terms used in this disclosure, reference can be made to the standard documents.

The following technologies can be applied to a variety of wireless access technologies such as Code Division Multiple Access (CDMA), Frequency Division Multiple Access (FDMA), Time Division Multiple Access (TDMA), Orthogonal Frequency Division Multiple Access (OFDMA), or Single Carrier Frequency Division Multiple Access (SC-FDMA). CDMA may be implemented as a wireless technology (or radio technology) such as Universal Terrestrial Radio Access (UTRA) or CDMA2000. TDMA may be implemented as a wireless technology such as Global System for Mobile communications (GSM)/General Packet Radio Service (GPRS)/Enhanced Data Rates for GSM Evolution (EDGE). OFDMA may be implemented as a wireless technology such as Institute of Electrical and Electronics Engineers (IEEE) 802.11 (Wi-Fi), IEEE 802.16 (WiMAX), IEEE 802-20, or Evolved UTRA (E-UTRA). UTRA is a part of the Universal Mobile Telecommunications System (UMTS). 3rd Generation Partnership Project (3GPP) long term evolution (LTE) is a part of the Evolved UMTS (E-UMTS) which uses E-UTRA. 3GPP LTE employs OFDMA in downlink and employs SC-FDMA in uplink. LTE-Advanced (LTE-A) is an evolution of 3GPP LTE. WiMAX may be explained by the IEEE 802.16e standard (WirelessMAN-OFDMA Reference System) and the advanced IEEE 802.16m standard (WirelessMAN-OFDMA Advanced System). Although the following description focuses on the 3GPP LTE and 3GPP LTE-A system for clarity, the spirit of the present invention is not limited to the 3GPP LTE and 3GPP LTE-A system.

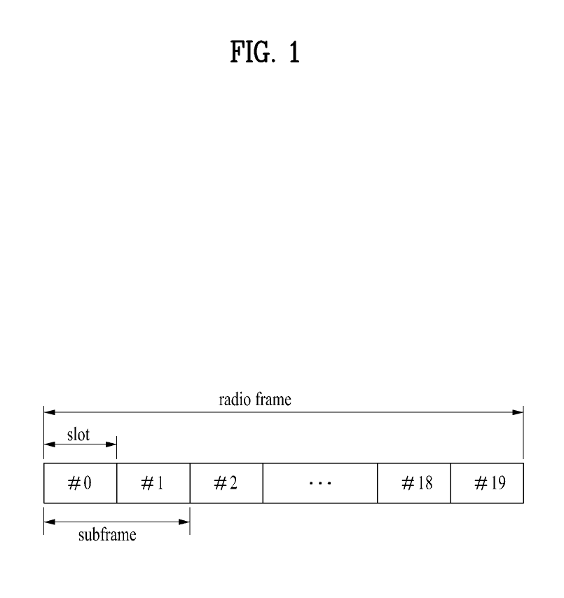

FIG. 1 illustrates the structure of a radio frame used in the 3GPP LTE system. A radio frame includes 10 subframes and each subframe includes 2 slots in the time domain. A unit time in which one subframe is transmitted is defined as a Transmission Time Interval (TTI). For example, one subframe may have a length of 1 ms and one slot may have a length of 0.5 ms. One slot may include a plurality of OFDM symbols in the time domain. Because the 3GPP LTE system uses OFDMA in downlink, an OFDM symbol represents one symbol period. One symbol may be referred to as an SC-FDMA symbol or a symbol period in the uplink. A Resource Block (RB) is a resource allocation unit which includes a plurality of consecutive subcarriers in a slot. This radio frame structure is purely exemplary. Thus, the number of subframes included in a radio frame, the number of slots included in a subframe, or the number of OFDM symbols included in a slot may vary in various ways.

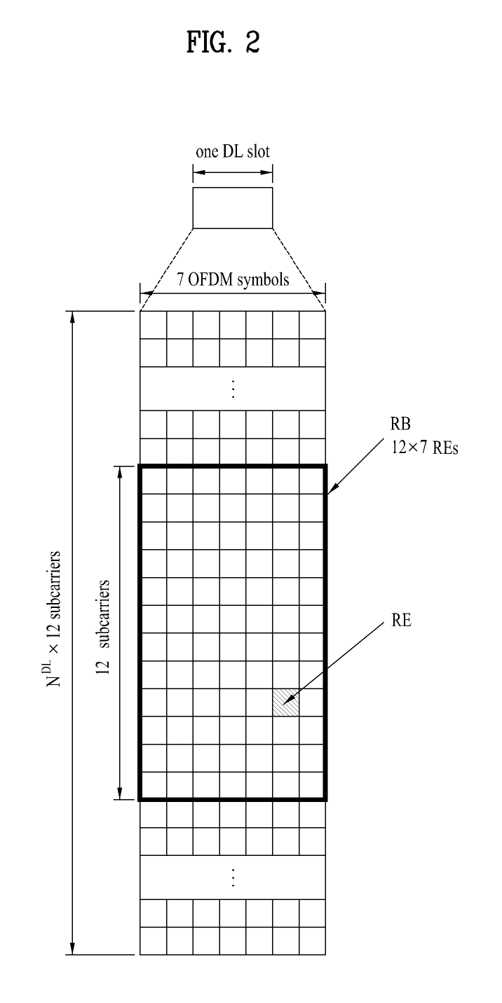

FIG. 2 illustrates a resource grid in a downlink slot. Although one downlink slot includes 7 OFDM symbols in the time domain and one RB includes 12 subcarriers in the frequency domain in the example of FIG. 2, the present invention is not limited to this example. For example, one slot may include 6 OFDM symbols when extended Cyclic Prefixes (CPs) are applied while one slot includes 7 OFDM symbols when normal CPs are applied. Each element on the resource grid is referred to as a resource element (RE). One resource block (RB) includes 12×7 resource elements. The number of RBs (N^{DL}) included in one downlink slot is determined based on a downlink transmission bandwidth. The structure of the uplink slot may be identical to the structure of the downlink slot.

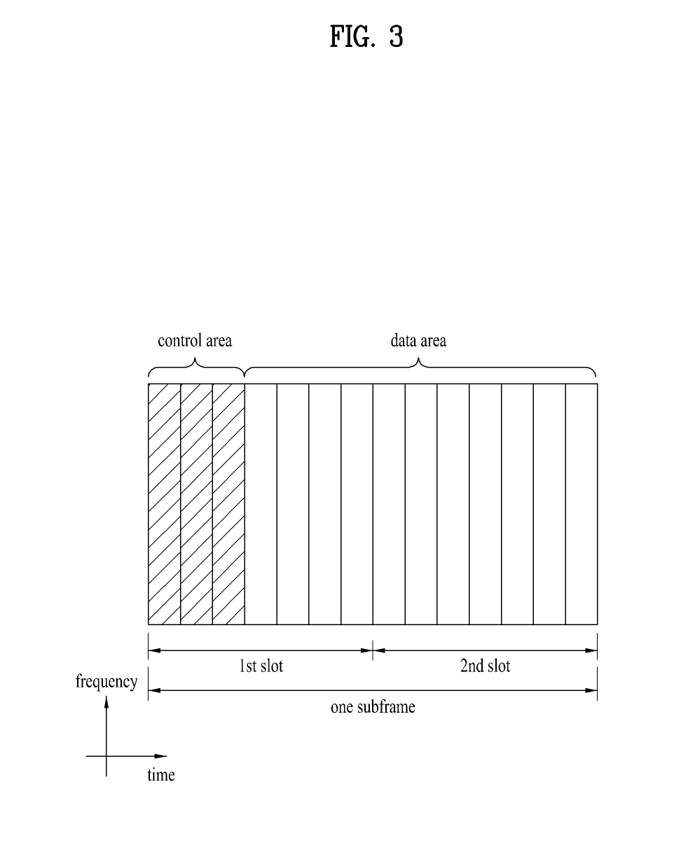

FIG. 3 illustrates the structure of a downlink subframe. Up to the first 3 OFDM symbols of a first slot within one subframe correspond to a control area to which a control channel is allocated. The remaining OFDM symbols correspond to a data area to which a Physical Downlink Shared Channel (PDSCH) is allocated. Downlink control channels used in the 3GPP LTE system include, for example, a Physical Control Format Indicator Channel (PCFICH), a Physical Downlink Control Channel (PDCCH), and a Physical Hybrid automatic repeat request Indicator Channel (PHICH). The PCFICH is transmitted in the first OFDM symbol of a subframe and includes information regarding the number of OFDM symbols used to transmit a control channel in the subframe. The PHICH includes a HARQ ACK/NACK signal as a response to uplink transmission. Control information transmitted through the PDCCH is referred to as Downlink Control Information (DCI). The DCI includes uplink or downlink scheduling information or includes an uplink transmission power control command for a UE group. The PDCCH may include a resource allocation and transmission format of a Downlink Shared Channel (DL-SCH), resource allocation information of an Uplink Shared Channel (UL-SCH), paging information of a Paging Channel (PCH), system information of the DL-SCH, information regarding resource allocation of a higher layer control message such as a Random Access Response (RAR) that is transmitted in the PDSCH, a set of transmission power control commands for individual UEs in a UE group, transmission power control information, and information regarding activation of Voice over IP (VoIP). A plurality of PDCCHs may be transmitted within the control area. The UE may monitor the plurality of PDCCHs. The PDCCHs are transmitted in an aggregation of one or more consecutive Control Channel Elements (CCEs). Each CCE is a logical allocation unit that is used to provide the PDCCHs at a coding rate based on the state of a radio channel. The CCE corresponds to a plurality of resource element groups. The format of the PDCCH and the number of available bits are determined based on a correlation between the number of CCEs and a coding rate provided by the CCEs. The base station (eNB) determines the PDCCH format according to a DCI that is transmitted to the UE, and adds a Cyclic Redundancy Check (CRC) to control information. The CRC is masked with a Radio Network Temporary Identifier (RNTI) according to the possessor or usage of the PDCCH. If the PDCCH is associated with a specific UE, the CRC may be masked with a cell-RNTI (C-RNTI) of the UE. If the PDCCH is associated with a paging message, the CRC may be masked with a paging indicator identifier (P-RNTI). If the PDCCH is associated with system information (more specifically, a system information block (SIB)), the CRC may be masked with a system information identifier and a system information RNTI (SI-RNTI). To indicate a random access response that is a response to transmission of a random access preamble from the UE, the CRC may be masked with a random access-RNTI (RA-RNTI).

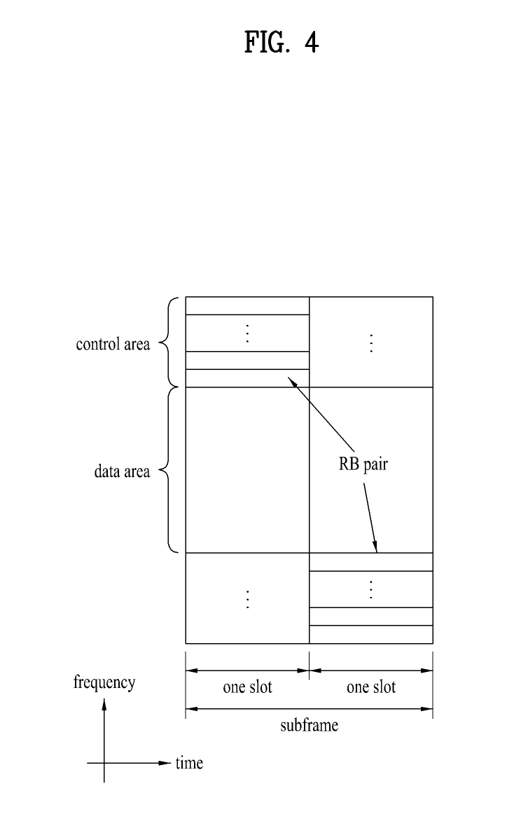

FIG. 4 illustrates the structure of an uplink subframe. The uplink subframe may be divided into a control area and a data area in the frequency domain. A Physical Uplink Control Channel (PUCCH) including uplink control information is allocated to the control area. A Physical Uplink Shared Channel (PUSCH) including user data is allocated to the data area. In order to maintain single carrier properties, one UE does not simultaneously transmit the PUCCH and the PUSCH. A PUCCH associated with one UE is allocated to an RB pair in a subframe. RBs belonging to the RB pair occupy different subcarriers in two slots. That is, the RB pair allocated to the PUCCH is “frequency-hopped” at a slot boundary.

Carrier Aggregation

The following is a description of Carrier Aggregation (CA). Carrier aggregation, which is being considered to be introduced into an evolved OFDM based mobile communication system, is a technology for a downlink or uplink transmission entity to simultaneously transmit data or control information in downlink or uplink through one or more carriers from among carriers which have been individually set for downlink or uplink (which may be referred to as component carriers or carrier bands). In the following description, an uplink component carrier is referred to as a UL CC for short and a downlink component carrier is referred to as a DL CC for short. A carrier or a component carrier may be referred to as a cell as described in the functional configuration aspect in the 3GPP standard. That is, a DL CC may be referred to as a DL cell or a UL CC may be referred to as a UL cell.

Downlink carrier aggregation may be described as support of downlink transmission of an eNB to a UE using frequency-domain resources (subcarriers or Physical Resource Blocks (PRBs)) in bands of one or more carriers in certain time-domain resources (which are in units of subframes). Uplink carrier aggregation may be described as support of uplink transmission of a UE to an eNB using frequency-domain resources (subcarriers or PRBs) of bands of one or more carriers in certain time-domain resources (which are in units of subframes).

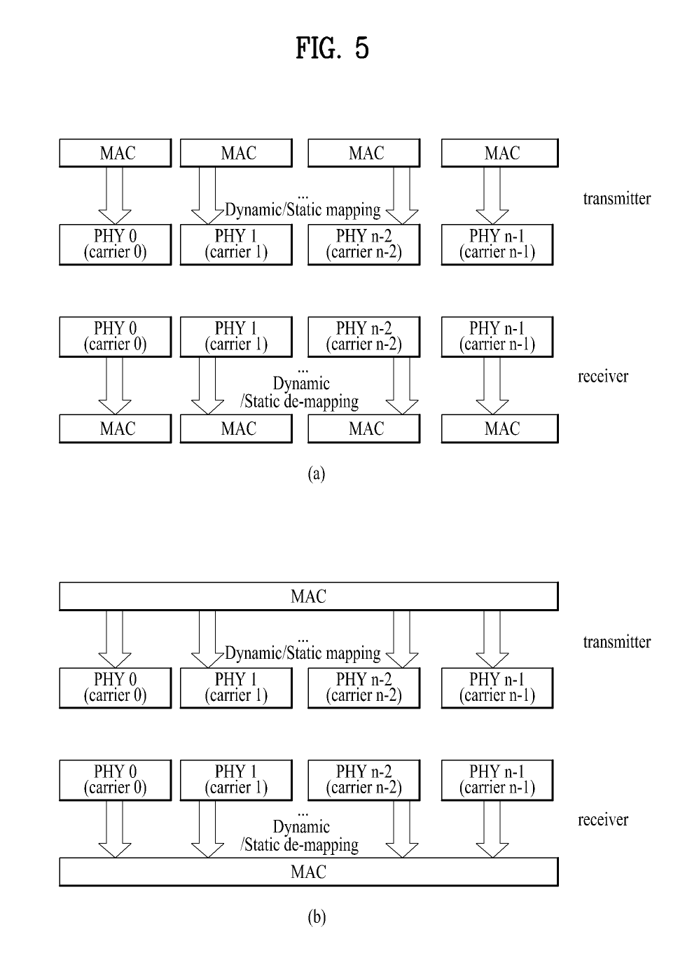

The configurations of a physical layer (first layer, L1) and a MAC layer (second layer, L2) of a system that supports multiple carriers are described below with reference to FIG. 5. An eNB (base station) in a conventional wireless communication system that supports a single carrier may be provided with a single physical (PHY) layer that supports a single carrier and a single Medium Access Control (MAC) entity that controls one PHY entity. For example, a base band processing operation may be performed in the PHY layer. In the MAC layer, for example, a transmitter may perform MAC Protocol Data Unit (PDU) generation and L1/L2 scheduler operations including MAC/RLC sub-layer operations. A MAC PDU packet block of the MAC layer is converted into a transport block through a logical transport layer and the transport block is then mapped to a PHY layer input information block. The MAC layer, which is expressed as the entirety of the L2 layer in FIG. 2, may be applied as a layer including MAC/RLC/PDCP sub-layers. The same may be applied to all descriptions of the MAC layer in the present invention.

A plurality of MAC-PHY entities may be provided in a multi-carrier support system. That is, a transmitter and a receiver of a multi-carrier support system may be configured such that one MAC-PHY entity is associated with each of the n component carriers as shown in FIG. 5(a). Since independent PHY and MAC layers are provided for each component carrier, a PDSCH for each component carrier is generated from a MAC PDU in the physical layer.

Alternatively, one common MAC entity and a plurality of PHY entities may be configured in the multi-carrier support system. That is, a transmitter and a receiver of a multi-carrier support system may be configured such that, as shown in FIG. 5(b), n PHY entities corresponding respectively to n component carriers are provided and a common MAC entity that controls the n PHY entities is provided. In this case, a MAC PDU from one MAC layer may be divided into a plurality of transport blocks corresponding respectively to a plurality of component carriers in a transport layer. Alternatively, when a MAC PDU is generated in the MAC layer and an RLC PDU is generated in the RLC layer, each of the MAC PDU and the RLC PDU may be individually divided according to respective component carriers. In this manner, a PDSCH is generated for each component carrier in the PHY layer.

A PDCCH, which carries a plurality of control information for L1/L2 control signaling generated from a packet scheduler of the MAC layer, may be mapped to physical resources of each individual component carrier to be transmitted. Here, a PDCCH including control information (a downlink or uplink grant) for PDSCH or PUSCH transmission for a specific UE may be encoded individually for each component carrier in which the PDSCH/PUSCH is transmitted. This PDCCH may be referred to as a separate-coded PDCCH. A plurality of control information for PDSCH/PUSCH transmission of a plurality of component carriers may be constructed into a single PDCCH to be transmitted, which may be referred to as a joint-coded PDCCH.

In order to support carrier aggregation, a connection needs to have been established between an eNB and a UE to allow a control channel (PDCCH or PUCCH) and/or a shared channel (PDSCH or PUSCH) to be transmitted therebetween or there is a need to prepare for such connection establishment or setting. Carrier measurement and/or reporting are needed for such connection/connection setting and it is possible to assign component carriers which are to be subjected to such measurement and/or reporting. Here, the term “to assign component carriers” means to set component carriers used for downlink/uplink transmission (specifically, to set the number of component carriers and component carrier indices) from among uplink/downlink component carriers configured in an eNB taking into consideration system environments and capabilities of the specific UE.

Here, in the case in which component carrier assignment is controlled by a third layer (L3) Radio Resource Management (RRM) unit, UE-specific RRC signaling may be used. Cell-specific or cell-cluster-specific RRC signaling may also be used. When dynamic control such as component carrier activation/deactivation setting is required for component carrier assignment, a specific PDCCH may be used for L1/L2 control signaling or a PDCCH in the form of an L2 MAC message or a physical control channel dedicated to component carrier assignment control information may be used. On the other hand, in the case in which component carrier assignment is controlled by a packet scheduler, a specific PDCCH may be used for L1/L2 control signaling or a PDCCH in the form of an L2 MAC message or a physical control channel dedicated to component carrier assignment control information may be used.

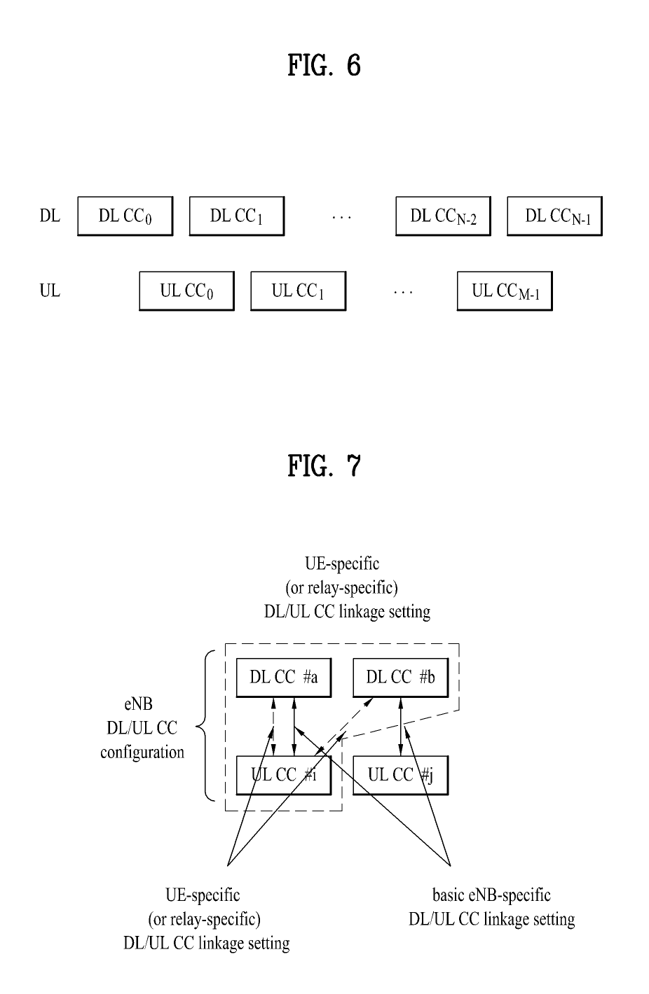

FIG. 6 conceptually illustrates component carriers (CCs) for downlink and uplink. Downlink (DL) and uplink (UL) CCs of FIG. 6 may be allocated by an eNB (cell) or a relay and the number of DL CCs may be set to N and the number of UL CCs may be set to M.

Processes for establishing an RRC connection (such as cell search, system information acquisition/reception, and initial random access processes) may be performed based on one CCE for each of the downlink and uplink through an initial access or initial deployment procedure for a UE and therefore each UE may receive UE-specific carrier setting information from an eNB through dedicated signaling (UE-specific RRC signaling or UE-specific L1/L2 PDCCH signaling). In the case in which UE carrier setting is performed commonly for UEs of each eNB (each cell or cell cluster), carrier setting information may be provided through cell-specific RRC signaling or cell-specific, UE-common L1/L2 PDCCH signaling. Alternatively, carrier configuration information for carriers configured by an eNB may be signaled to each UE through system information for RRC connection establishment or may be signaled to each UE through cell-specific RRC signaling or system information after the RRC connection establishment process.

Although DL/UL CC setting is described mainly focusing on the relationship between an eNB and a UE in this specification, the present invention is not limited thereto. For example, the present invention may be equally applied to the case in which a relay provides each UE in the coverage of the relay with DL/UL CC setting information for the UE. The present invention may also be equally applied to the case in which an eNB provides a relay in the coverage of the eNB with DL/UL CC setting information for the relay. That is, it should be noted that, although DL/UL CC setting is described below mainly focusing on the relationship between an eNB and a UE in the following description for the sake of clarity, the same may be applied to (the access uplink and downlink) between a relay and a UE or (the backhaul uplink and downlink) between an eNB and a relay.

A DL/UL CC linkage may be set explicitly through definition of signaling parameters or may be set implicitly in the procedure in which DL/UL CCs are assigned to each individual UE in a UE-specific manner as described above.

FIG. 7 illustrates an exemplary DL/UL CC linkage. Specifically, FIG. 7 shows a DL/UL CC linkage defined as 2 DL CCs (DL CC #a and DL CC #b) and 1 UL CC (UL CC #i) are assigned to a UE in the case in which an eNB configures 2 DL CCs (DL CC #a and DL CC #b) and 2 UL CCs (UL CC #i and UL CC #j). In the DL/UL CC linkage setting of FIG. 7, solid lines indicate setting of linkages between DL CCs and UL CCs which are basically configured by the eNB. This may be defined in SIB 2. In the DL/UL CC linkage setting of FIG. 7, dotted lines indicate setting of linkages between DL CCs and UL CCs which are set for a specific UE. The DL/UL CC linkage setting of FIG. 7 is merely exemplary and the present invention is not limited thereto. That is, in various embodiments of the present invention, the respective numbers of DL CCs and UL CCs configured by the eNB may be set to arbitrary values and the respective numbers of DL CCs and UL CCs which are set or assigned in a UE-specific manner from among the configured DL CCs and UL CCs may be set to arbitrary values and associated DL/UL CC linkages may also be defined in a differently manner from that of FIG. 7.

A primary CC (PCC) (or primary cell (P-cell)) or an anchor CC (or anchor cell) may be set from among DL and UL CCs which are configured or set for the UE. In one example, a DL PCC (or DL P-cell) which is always used to transmit configuration/reconfiguration information of RRC connection establishment may be set. In another example, a UL CC which transmits a PUCCH for transmission of Uplink Control Information (UCI) by a UE may be set as a UL PCC (or UL P-cell).

Basically, one DL PCC (DL P-cell) and one UL PCC (UL P-cell) are set for each UE in a UE-specific manner. In the case in which a large number of CCs are set for a UE or in a situation in which a plurality of eNBs may set CCs for a UE, one or more eNBs may set one or a plurality of DL PCCs (P-cells) and/or UL PCCs (P-cells) for a UE. First, it is possible to consider a method in which an eNB is able to arbitrarily configure a linkage between a DL PCC (P-cell) and a UL PCC (P-cell) in a UE-specific manner. In a simpler method, a linkage between a DL PCC (P-cell) and a UL PCC (P-cell) may be configured based on the relationship of a basic linkage which is signaled through a System Information Block (or Base) (SIB) 2 which has already been defined in LTE Release-8 (Rel-8). The DL PCC (P-cell) and a UL PCC (P-cell), whose linkage is set as described above, may be collectively referred to as a P-cell in a UE-specific manner.

Uplink Scheduling Control Information

A UE performs blind decoding in order to receive PDCCHs allocated to the UE in a subframe. Blind decoding is a process for attempting to perform PDCCH decoding according to each of the hypotheses which have been set associated with various formats (for example, a PDCCH DCI format) of Downlink Control Information (DCI). The DCI may have various predetermined formats (for example, various bit lengths). The format of DCI which is to be transmitted to the UE is not previously signaled to the UE and the UE is set to perform PDCCH decoding. For example, when the UE has succeeded in PDCCH decoding according to one hypothesis, the UE can perform an operation according to the DCI. However, when the UE has not succeeded in PDCCH decoding, the UE may attempt to perform PDCH decoding according to another hypothesis associated with the format of the DCI. Upon determining through the blind decoding that the received PDCCH is destined for the UE, the UE may receive a PDSCH or transmit a PUSCH according to control information acquired through the PDCCH.

For example, when the UE has received PDCCH DCI format 0, the UE may acquire information regarding PUSCH scheduling and transmit a PUSCH according to the acquired control information. DCI format 0 includes control information for scheduling uplink single-codeword transmission in a conventional LTE system. This may also be referred to as UL grant information for uplink single-codeword transmission.

In an advanced wireless communication system (for example, LTE-A system), a DCI format for supporting uplink transmission of multiple Transport Blocks (TBs) may be designed, which may be referred to as DCI format 4 for discrimination from the existing DCI formats. In addition, in a multi-carrier support system, a Carrier Indicator Field (CIF) may be additionally defined to indicate which uplink carrier is associated with uplink scheduling information.

The DCI format 0 and DCI format 4 described above may be collectively referred to as UL grant information.

The UL grant information may include information regarding PUSCH resource allocation and information such as a New Data Indicator (NDI), a Redundancy Version (RV), and a Modulation and Coding Scheme (MCS) for a PUSCH. In the case in which uplink multi-TB transmission is scheduled, MCS, RV, and NDI information may be defined for each TB. The UL grant information may also include a ‘CQI request’ field. The CQI request field is defined to request report aperiodic CQI, PMI, and RI using a PUSCH. For example, when the CQI request field is set to 1, the UE transmits a CQI, PMI, and RI report through a PUSCH in an aperiodic manner (i.e., according to an instruction of the eNB).

Uplink Control Information (UCI)

The UCI includes a Scheduling Request (SR) for uplink transmission, Channel Status Information (CSI) of a downlink channel, an ACK/NACK for downlink data transmission, and the like. The UCI may be transmitted through a Physical Uplink Control Channel (PUCCH) or a Physical Uplink Shared Channel (PUSCH).

First, UCI transmission through a PUCCH is described below.

A PUCCH format is defined according to the type of control information included in the PUCCH, a modulation scheme, or the like. PUCCH format 1 is used for transmission of an SR, PUCCH format 1a or 1b is used for transmission of a HARQ ACK/NACK, PUCCH format 2 is used for transmission of CQI (which collectively refers to an RI, a PMI, and CQI), and PUCCH format 2a/2b is used for transmission of CQI and a HARQ ACK/NACK. PUCCH format 1a or 1b is used when a HARQ ACK/NACK is transmitted alone in a subframe and PUCCH format 1 is used when an SR is transmitted alone in a subframe.

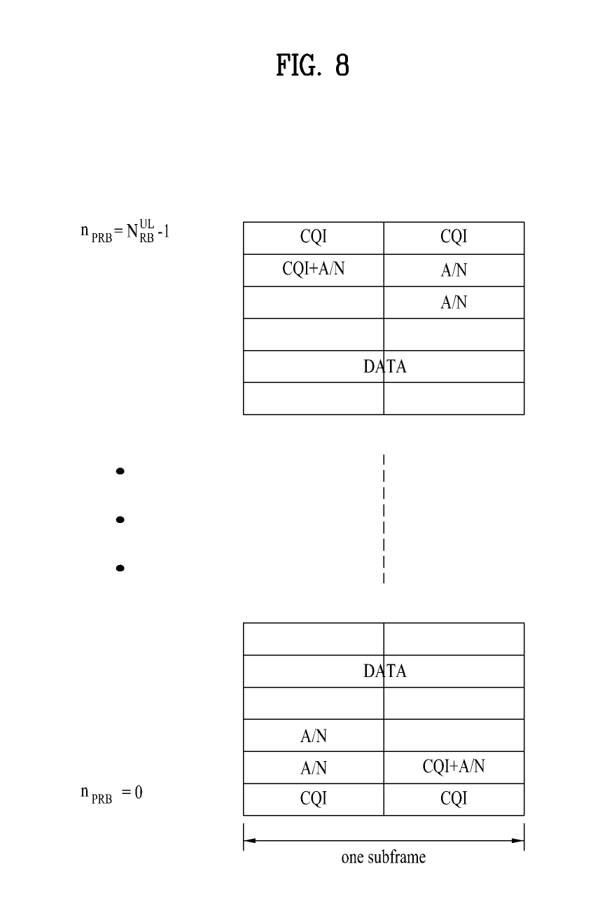

FIG. 8 illustrates a structure of resource mapping of a PUCCH in an uplink physical resource block. N_{RB}^{UL} denotes the number of resource blocks in uplink and n_{PRB} denotes a physical resource block number. A PUCCH is mapped to both edges of an uplink resource block. CQI resources may be mapped to physical resource blocks immediately next to the edges of the frequency band and ACK/NACK resources may be mapped to physical resource blocks next to the physical resource blocks.

Next, UCI transmission through a PUSCH is described below. A method in which UCI is multiplexed with data and is then transmitted through a PUSCH may be referred to as a piggyback scheme.

Data which is to be multiplexed with UCI is processed in the following manner. A Transport Block (TB) CRC is attached to a TB which is transmitted in uplink and the CRC-attached TB is then divided into a plurality of Code Blocks (CBs) according to size. Channel coding is performed on the CBs after a CB CRC is attached to the CBs. The channel-coded data CBs are rate-matched and the rate-matched CBs are then combined.

The combined CBs are multiplexed with the UCI. CQI/PMI is multiplexed with the data after the CQI/PMI is channel-coded separately from the data. An RI is also channel-coded separately from the data. ACK/NACK information is also channel-coded separately from the data, the CQI/PMI, and the RI. The CQI/PMI which is multiplexed with the data is input to a channel interleaver and the separately channel-coded RI and ACK/NACK are input to the channel interleaver, which performs channel interleaving on the input information to generate an output signal. The output signal is mapped to PUSCH physical resources to be transmitted in uplink.

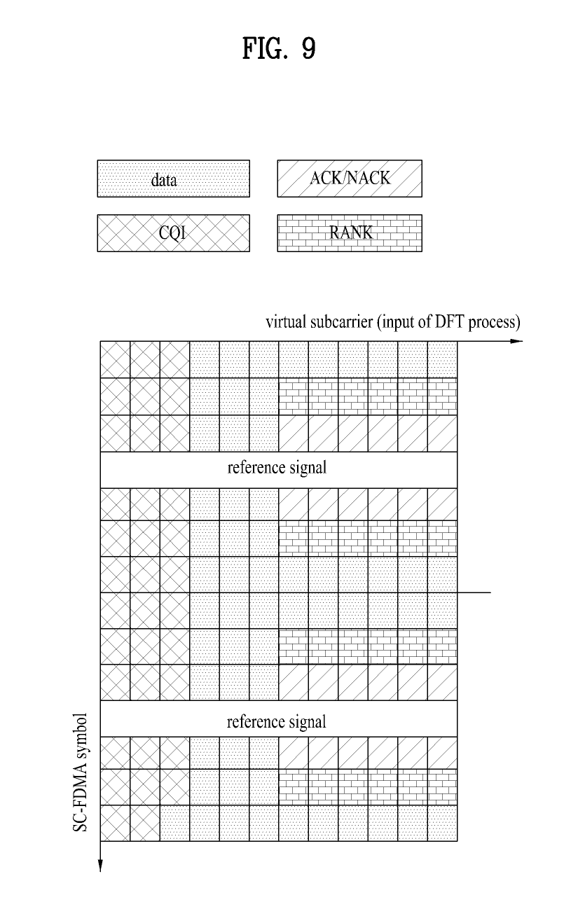

FIG. 9 illustrates a method in which uplink data and UCI are mapped to PUSCH physical resources. Multiplexed CQI/PMI and data are mapped to Resource Elements (RE) in a time-first manner. An encoded ACK/NACK is inserted adjacent to Demodulation Reference Signal (DM RS) symbols through puncturing and an RI is mapped to REs next to REs at which the ACK/NACK is located. Resources for the RI and the ACK/NACK may occupy up to 4 SC-FDMA symbols.

When data and control information are simultaneously transmitted in an uplink shared channel, mapping is performed in the order of RI→CQI/PMI and data→ACK/NACK. That is, after the RI is first mapped, the CQI/PMI and data is mapped in a time-first manner to REs other than the REs to which the RI has been mapped. Mapping of the ACK/NACK is performed while puncturing the CQI/PMI and data which has already been mapped.

By multiplexing data and uplink control information in the above manner, it is possible to satisfy single carrier characteristics. Thus, it is possible to accomplish uplink transmission which maintains a low Peak to Average Power Ratio (PAPR).

Unlike the above method, an eNB may instruct UEs which are in good channel environments in a UE-specific manner (i.e., may instruct a specific one of the UEs) or in a cell-specific manner (i.e., may instruct UEs in a cell) to simultaneously transmit a PUSCH and a PUCCH in the case in which UCI and data to be transmitted through the PUCCH and the PUSCH are present through an uplink transmission subframe in an uplink carrier. In this case, each UE simultaneously transmits UCI through a PUCCH and data through a PUSCH. In the following description of the present invention, it is to be noted that, in the case in which the eNB instructs simultaneous transmission of a PUCCH and a PUSCH, it is possible to apply a method in which UCI is transmitted through a PUCCH even when a PUSCH is present instead of the above method in which UCI is piggybacked and transmitted on a PUSCH.

UL/DL Scheduling Information Transmission in Carrier Aggregation System

Downlink scheduling information is control information through which an eNB notifies a UE of a scheme and downlink time-frequency resources through which downlink data is to be transmitted, which may be referred to as DL assignment information. Uplink scheduling information is control information through which an eNB notifies a UE of a scheme and uplink time-frequency resources through which uplink data is to be transmitted, which may be referred to as UL grant information. Such UL/DL scheduling information is transmitted through a Physical Downlink Control Channel (PDCCH) and a Downlink Control Information (DCI) format may be defined according to the usage thereof.

In the conventional wireless communication system, there is no need to signal an UL/DL carrier whose data transmission is scheduled since only one UL carrier and only one DL carrier are present between an eNB and a UE. However, in the carrier aggregation system, there is a need to signal a carrier through which UL/DL data is to be transmitted since the carrier aggregation system supports UL/DL transmission in multiple carriers.

In the carrier aggregation system, it is possible to take into consideration whether or not cross-carrier scheduling is applied. Cross-carrier scheduling for downlink transmission corresponds to, for example, the case in which control information (a DL assignment PDCCH) for scheduling PDSCH transmission in downlink CC #j is transmitted in a DL CC (DL CC #i) different from the downlink CC #j. Cross-carrier scheduling for uplink transmission corresponds to, for example, the case in which control information (a UL grant PDCCH) for scheduling PUSCH transmission in uplink CC #j is transmitted in a DL CC (DL CC #i) different from a DL CC (for example, downlink CC #j) with which a linkage with UL CC #j has been set. On the other hand, the case in which a DL assignment PDCCH for PDSCH transmission in DL CC #j is transmitted through DL CC #j or a UL grant PDCCH for PUSCH transmission in UL CC #j is transmitted through DL CC #j with which a linkage with UL CC #j has been set corresponds to the case in which cross-carrier scheduling has not been applied.

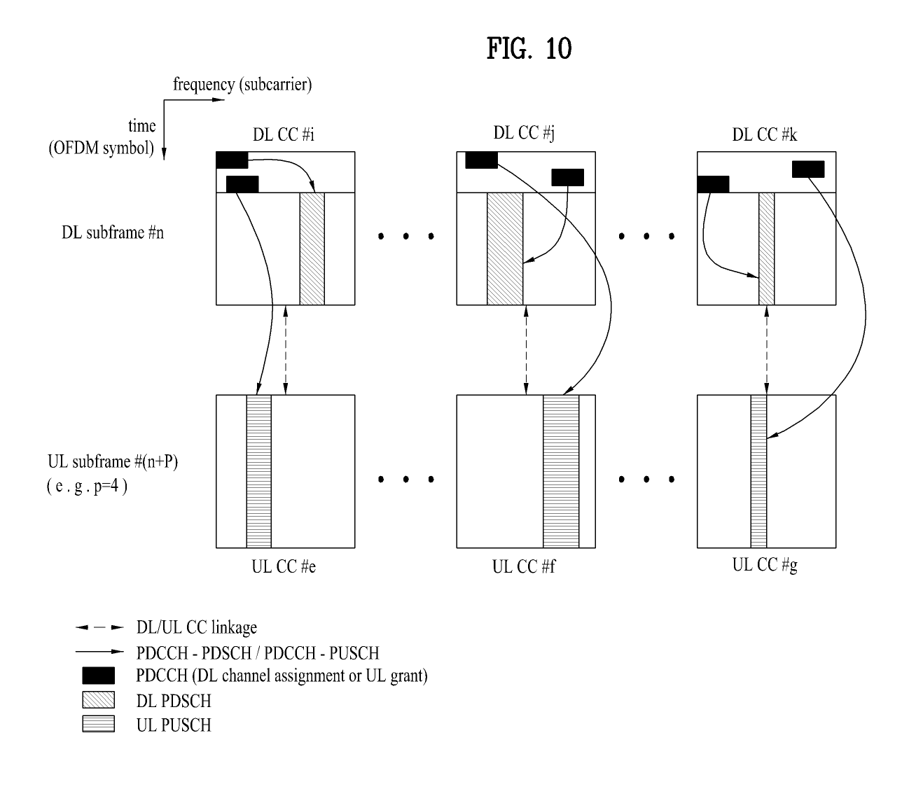

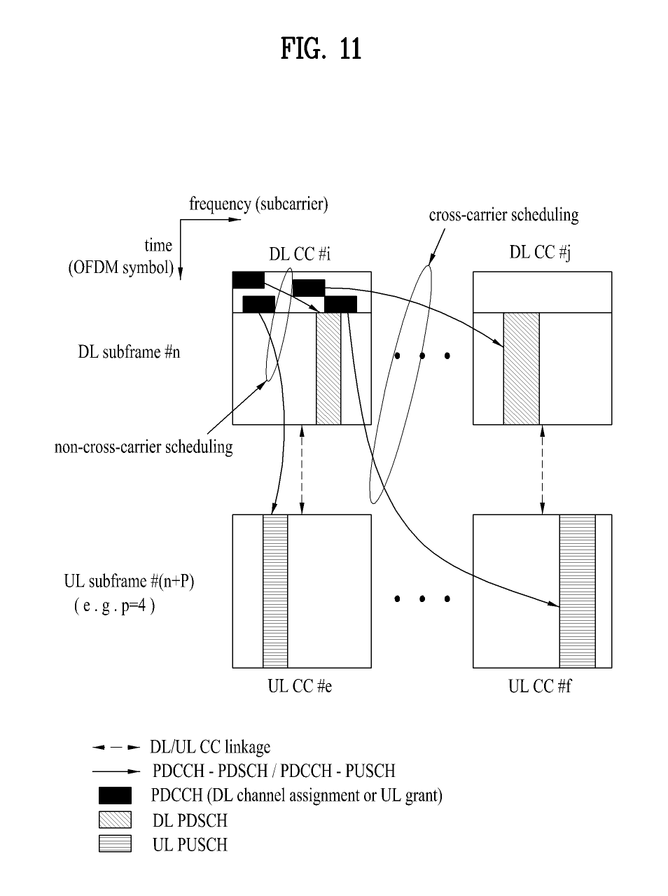

FIG. 10 illustrates the case in which cross-carrier scheduling has not been applied and FIG. 11 illustrates the case in which cross-carrier scheduling has been applied.

Although it is assumed in the method of FIGS. 10 and 11 that DL CCs and UL CCs are symmetrically configured by an eNB, the method of FIGS. 10 and 11 is not limited thereto and may be applied to the case in which DL CCs and UL CCs are asymmetrically configured. Time/frequency positions of a PDCCH, a PDSCH, and a PUSCH in FIGS. 10 and 11, which are conceptual drawings illustrating cross-carrier scheduling, are merely exemplary and the present invention is not limited thereto. In addition, time/frequency positions of PDCCHs in a downlink control area in FIGS. 10 and 11 are merely exemplary to express that PDCCHs are multiplexed and the present invention is not limited thereto.

As shown in FIG. 10, in the case in which cross-carrier scheduling is not applied, a DL CC which transmits a downlink assignment PDCCH and a DL CC which transmits a PDSCH are the same carrier and a DL CC which transmits an uplink grant PDCCH and a UL CC which transmits a PUSCH follow the setting of a DL/UL linkage.

For example, scheduling (DL channel assignment) for PDSCH transmission in DL CC #i is provided through a PDCCH in the DL CC #i and scheduling (UL grant) for PUSCH transmission in UL CC #e is provided through a PDCCH in DL CC #i with which a linkage with the UL CC #e has been set. Similarly, PDSCH transmission in DL CC #k and PUSCH transmission in UL CC #g may be scheduled through a PDCCH (DL assignment or UL grant) in DL CC #k according to the setting of a linkage between DL CC #k and UL CC #g. In addition, PDSCH transmission in DL CC #k and PUSCH transmission in UL CC #g may be scheduled through a PDCCH (DL assignment or UL grant) in DL CC #k according to the setting of a linkage between DL CC #k and UL CC #g.

As shown in FIG. 11, in the case in which cross-carrier scheduling is applied, a DL CC which transmits a downlink assignment PDCCH and a DL CC which transmits a PDSCH may be different carriers and a DL CC which transmits an uplink grant PDCCH and a UL CC which transmits a PUSCH may not follow the setting of a DL/UL linkage. For example, a downlink assignment PDCCH for scheduling PDSCH transmission in DL CC #i or an uplink grant PDCCH for scheduling PUSCH transmission in UL CC #e can not only be transmitted through a control area of DL CC #i (which may be referred to as self-scheduling) but a downlink assignment PDCCH for scheduling PDSCH transmission in DL CC #j or uplink grant PDCCHs for scheduling PUSCH transmission in UL CC #f can also be multiplexed and transmitted through the control area of DL CC #i.

Such cross-carrier scheduling may be applied when a technology for significantly reducing transmission power in a specific DL CC or UL CC (soft silencing) or a technology for reducing transmission power to zero (hard silencing) is applied, when there is a need to guarantee frequency diversity of a PDCCH in the case in which DL CCs or UL CCs having a small bandwidth are configured, when a cell-specific or UE-specific primary carrier or anchor carrier is set, or when there is a need to reduce PDCCH blind decoding overhead of UEs.

In addition, cross-carrier scheduling may be set in a UE-specific manner or may be set commonly for UEs in a cell (i.e., may be set in a cell-specific manner). When a relay is considered as a downlink reception entity, cross-carrier scheduling may be set in a relay-specific manner or may be set commonly for relays in a cell (i.e., may be set in a cell-specific manner) and, when a relay is considered as a downlink transmission entity, cross-carrier scheduling may be set in a UE-specific manner or may be set commonly for UEs in a relay (i.e., may be set in a relay-specific manner).

That is, cross-carrier scheduling may be applied to transmission of an uplink grant PDCCH transmission or a downlink assignment PDCCH for PUSCH transmission in one or more UL CCs configured for a specific UE or for PDSCH transmission in one or more DL CCs configured for the specific UE and may be applied to transmission of an uplink grant PDCCH transmission or a downlink assignment PDCCH for PUSCH transmission in one or more UL CCs configured for a specific cell or for PDSCH transmission in one or more DL CCs configured for the specific cell. The same is true for the case in which a relay is considered.

UCI Transmission in Multi-Carrier System

In a wireless communication system that supports multiple carriers, transmission of one or more PUSCHs may be scheduled in a plurality of uplink carriers. One of the plurality of uplink carriers may be assigned as an uplink primary carrier (primary CC or P-cell) or an anchor carrier (anchor CC or anchor-cell).

In this case, UCI such as a HARQ ACK/NACK, CSI (CQI/PMI/RI), and an SR may be transmitted in a PUSCH. Transmission of UCI in a PUSCH may be performed according to a given data/control information multiplexing method and may be performed under a certain condition or may be unconditionally performed. In this specification, various schemes in which UCI is transmitted in a PUSCH are collectively referred to as a UCI piggyback transmission scheme.

Generally, resource allocation and transmission type allocation for a PUSCH on which UCI is piggybacked are indicated by an explicit UL grant PDCCH or may be implicitly indicated by a previous UL grant message. UCI may be allowed to be piggybacked on a PUSCH of an uplink carrier different from an uplink carrier in which UCI is transmitted in a PUCCH, which may be referred to as a cross-carrier UCI piggyback scheme.

In the following description, it is assumed that, when a UE transmits UCI through a PUCCH or a PUSCH, an eNB may perform blind detection or decoding on both the PUCCH and the PUSCH.

In the multi-carrier system, when a UE has missed UL grant information when transmitting UCI, there may be ambiguity from the viewpoint of the eNB which receives the UCI. Here, the term “to miss UL grant information” means that the UE has failed in PDCCH blind decoding.

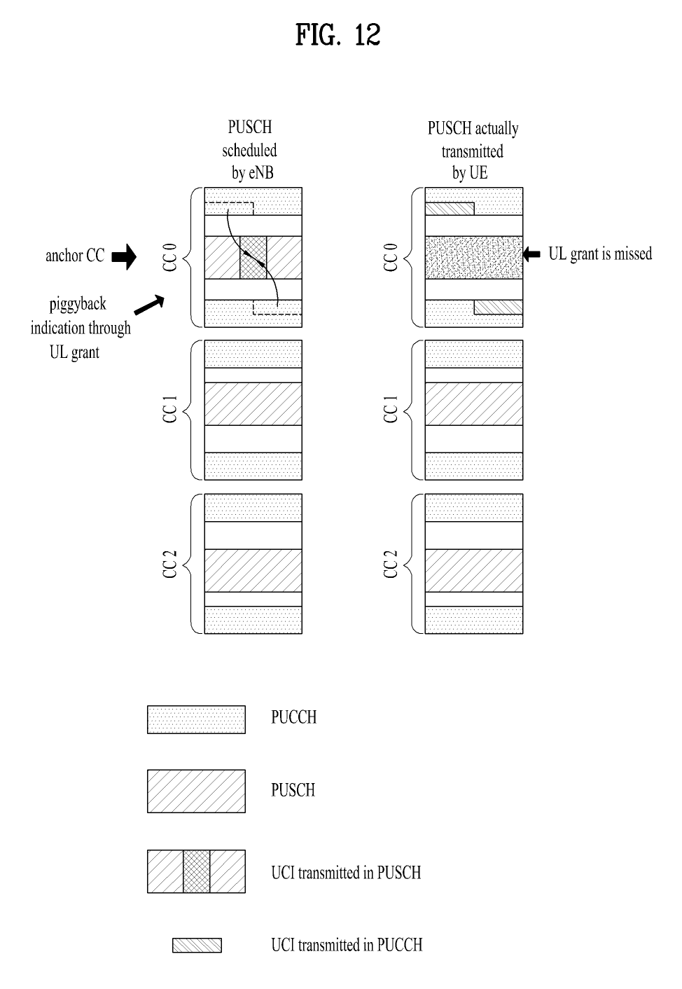

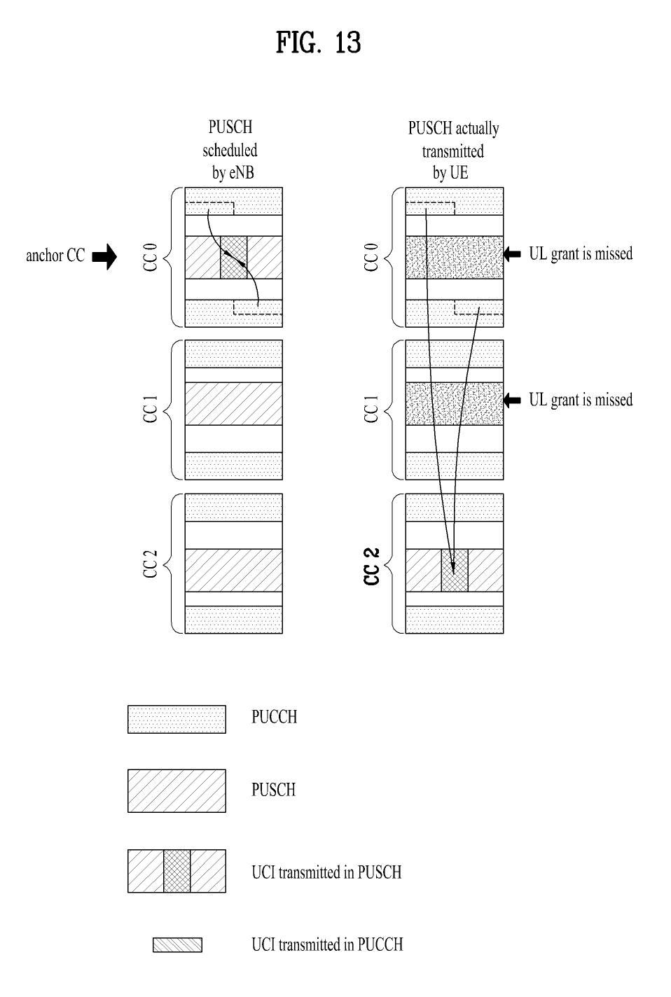

FIGS. 12 and 13 illustrate ambiguity that occurs in association with reception of UCI by an eNB when a UE has failed to receive a UL grant. FIGS. 12 and 13 exemplarily show the case in which 3 uplink carriers (CC 0, CC 1, and CC 2) are set. In the examples of FIGS. 12 and 13, it is assumed that CC0 is assigned as a primary carrier (or as an anchor CC).

FIG. 12 shows an example in which a PUSCH on which UCI is to be transmitted through piggyback is selected according to an instruction provided through a UL grant (i.e., the case in which UCI piggyback is configured through a UL grant). In the example of FIG. 12, through a UL grant, an eNB instructs a UE to transmit UCI through piggyback on a PUSCH in CC 0. In addition, it is assumed in the example of FIG. 12 that the eNB can provide the UE with a UL grant for scheduling the UE's transmission of a PUSCH in each of CC 1 and CC 2 and that the UE has received a UL grant for CC 1 and CC 2. The UE may perform PUSCH transmission in CC 1 and CC 2 as scheduled by the UL grant. Here, a PUCCH and a PUSCH may be simultaneously transmitted. If the UE has missed the UL grant for CC 0, the UE does not know that PUSCH transmission has been scheduled in CC 0 and that it has been indicated that UCI is to be transmitted through piggyback on a PUSCH of CC 0. As described above, the UE operates to identify a PUSCH on which UCI is to be transmitted through piggyback according to an indication (or instruction) provided by a UL grant. However, since the UE has failed to receive a UL grant for CC 0, the UE determines that no PUSCH on which UCI is to be transmitted through piggyback has not been indicated and then transmits UCI through a PUCCH of an anchor CC (CC 0). In this case, since the UE actually transmits UCI through a PUCCH in CC 0 while the eNB expects that UCI will be transmitted through piggyback on a PUSCH of CC 0 from the UE, ambiguity occurs in association with the eNB's operation for receiving UCI. Such ambiguity as to UCI reception of the eNB increases load of the eNB since the eNB performs blind decoding for all possible cases in which UCI is transmitted such as the case in which UCI is transmitted through a PUCCH, the case in which UCI is transmitted through a PUSCH, and the case in which UCI is transmitted through an arbitrary uplink carrier.

FIG. 13 illustrates an example in which a PUSCH of a UL CC of the lowest index is selected as a PUSCH on which UCI is to be transmitted through piggyback (i.e., UCI piggyback is implicitly assigned). That is, the UE may operate to transmit UCI through piggyback on a PUSCH in an uplink carrier having the lowest index among scheduled PUSCHs. In the example of FIG. 13, the eNB may transmit, to the UE, a UL grant which schedules the UE's transmission of a PUSCH in CC 0, CC 1, and CC 2. The eNB expects that UCI will be transmitted through piggyback on a PUSCH of CC 0 which is the lowest index among those of the scheduled uplink carriers. However, in the example of FIG. 13, it is assumed that the UE misses a UL grant for CC 0 and CC 1 and receives a UL grant for only CC 3. In this case, the UE transmits only a PUCCH without a PUSCH in CC 0 and CC 1 and transmits both a PUCCH and a PUSCH in CC 2. Here, the UE transmits UCI through piggyback on a PUSCH of CC 2 which is the lowest index among those of PUSCHs scheduled according to a UL grant received by the UE. Thus, since the UE actually transmits UCI through piggyback on a PUSCH in CC 2 while the eNB expects that UCI will be transmitted through piggyback on a PUSCH of CC 0 from the UE, ambiguity occurs in association with the eNB's operation for receiving UCI.

In the example of FIG. 13, if the UE misses a UL grant for a PUSCH, which is intended by the eNB to transmit UCI, a PUSCH for UCI transmission may not match between the eNB and the UE. When there is no CRC check for UCI, reliability of the UCI is reduced since the UCI cannot be blind-decoded. In addition, in the case of CQI included in UCI, blind decoding is performed for PUSCH payload twice since it is unclear that rate matching is to be performed according to whether UCI is present or absent for each PUSCH. In this case, when a CRC error has occurred even after two blind decoding attempts have been made on the PUSCH payload, there is ambiguity as to an uplink carrier through which uplink data packets to be combined with a PUSCH are received when the eNB which has received the PUSCH combines the PUSCH with the uplink data packets received through the uplink carrier in a HARQ manner.

The following is a description of various methods of the present invention in which a UE can securely and efficiently transmit UCI through piggyback on a PUSCH even when the UE has missed a UL grant.

Method 1

This relates to a method for providing information enabling determination as to whether or not a UE has missed a UL grant. If it is possible to determine whether or not a UE has missed a UL grant, it is possible to more specifically define a UCI transmission operation of the UE and it is possible to reduce ambiguity that may occur in association with UCI reception by an eNB.

According to this method, an eNB may define an Uplink Grant Counter (UGC) field in a UL grant DCI format and a UE may analyze (or identify) the UGC field. The size of the UGC field may be defined according to the number of assignable uplink carriers and may be defined as 2 bits (which enable identification of up to 4 carriers) or 3 bits (which enables identification of up to 8 carriers). The 2-bit or 3-bit UGC field may be defined as an explicit field in a conventional DCI format and may be indicated implicitly through a field defined in a conventional DCI format.

When such a UGC field is defined, the order (or sequence) in which the UGC is counted may be defined in various manners.

In one example, the order in which the UGC is counted may be determined according to the value of a Carrier Indicator Field (CIF) assigned to each UL CC or a carrier index of a scheduled UL CC. The carrier index of the scheduled UL CC is the index of a carrier set by the system and the carrier index assigned according to the value of the CIF is the index of a carrier assigned by a PDCCH DCI format. For example, in the case in which 3 UL CCs (CC 0, CC 1, and CC 2) are assigned to a UE and uplink transmission in 2 of the 3 UL CCs (CC 1 and CC 2) is scheduled, the value of a UGC field of a UL grant for CC 0 may be set to 0 and the value of a UGC field of a UL grant for CC 2 may be set to 1.

In another example, the order in which the UGC is counted may be defined in the following manner. First, in the case in which uplink transmission in a UL PCC (or UL P-cell) is scheduled, the value of a UGC field of a UL grant for the UL PCC may be set to 0, which is the lowest value, and UGC field values, which sequentially increase by 1, may be set for the scheduled UL CC(s) other than the UL PCC in ascending order of the carrier index.

In the above description, carrier indices of UL CCs may be defined in a UE-specific manner for the configured or activated UL CC(s) or may be defined in a cell-specific manner (i.e., in a cell-common manner) for the UL CC(s) configured in a cell-specific manner. In the above description, the example in which UGC values are assigned in ascending order from the lowest UGC value may be replaced with an example in which UGC values are assigned in descending order from the highest UGC value. For example, in the above and following descriptions, a UGC field value of 0, which is the lowest value, may be replaced with a UGC field value of N which is the highest value.

The following is a description of operations of a UE for receiving a UL grant including the UGC field as described above.

(1) The UE may detect one or more UL grants through PDCCH blind decoding and may check a UGC field value included in each UL grant.

(2) When the UE has not decoded any UL grant, the UE may transmit UCI through a PUCCH in a UL PCC (or UL P-cell).

(3) When the UE has decoded a single UL grant, the UE may operate in the following manner.

If the value of a UGC field included in a UL grant decoded by the UE is 0, the UE may assume that the eNB has transmitted one UL grant and the UE has correctly received the UL grant. When the UE transmits a PUSCH according to the UL grant, the UE may perform data/control information multiplexing (i.e., may piggyback UCI on a PUSCH) in the case in which UCI piggyback has been set or has been implicitly assigned.

Here, when the eNB has transmitted a plurality of UL grants, the UE may receive only one UL grant whose UGC field value is 0 among the plurality of UL grants. Even when the UE has failed to decode some UL grants in this manner, there may be no problem in association with both piggyback transmission of UCI by the UE and UCI reception by the eNB if the UGC field value of the decoded UL grant is 0. For example, in the case in which the method in which UCI is piggybacked on a PUSCH having the lowest carrier index is applied, UCI is piggybacked on a PUSCH of UL CC index 0 even when the UE has received all of the plurality of UL grants and therefore it is possible to reduce ambiguity as to which UL CC carries a PUSCH on which UCI to be detected by the eNB is piggybacked.

On the other hand, if the value of the UGC field included in the UL grant decoded by the UE is not 0, the UE may determine that a UL grant other than the UL grant received by the UE is present. In this case, the UE may transmit a PUSCH according to the UL grant and may transmit UCI through a PUCCH in a UL PCC (or UL P-cell) simultaneously with transmission of the PUSCH.

In another example, if the value of the UGC field included in the UL grant decoded by the UE is not 0, the UE may determine that a UL grant other than the UL grant received by the UE is present and may then drop UCI transmission through a PUCCH and perform PUSCH transmission according to the UL grant or may drop PUSCH transmission scheduled according to the UL grant and transmit UCI through a PUCCH.

(4) When the UE has decoded a plurality of UL grants, the UE may operate in the following manner.

We can consider the case in which there is no empty part (i.e., there is no missing value) in an arrangement of UGC values included in a plurality of UL grants decoded by the UE. For example, we can consider the case in which continuous UGC values such as 0, 1, and 2 are arranged. In this case, the UE may assume that the UE has correctly received the plurality of UL grants transmitted by the eNB. In this case, when UCI piggyback has been set or has been implicitly assigned, the UE may perform data/control information multiplexing in a predefined PUSCH (i.e., may piggyback UCI on a predefined PUSCH). Here, the predefined PUSCH on which UCI is piggybacked may be determined according to one of the methods described above. For example, UCI may be piggybacked on a PUSCH in a UL CC having the lowest index, a PUSCH in a UL PCC (or UL P-cell), or a PUSCH in a UL CC having the lowest index among UL CC(s) other than the UL PCC.

Here, even when the UE has decoded only some of a plurality of UL grants transmitted by the eNB and has failed to receive the remaining UL grants, it may occur that there is no empty part (i.e., there is no missing value) in an arrangement of UGC values included in the decoded UL grants. For example, when the UE has received only 2 UL grants, a UL grant whose UGC value is set to 0 and a UL grant whose UGC value is set to 1, although the eNB has transmitted 3 UL grants having UGC values of 0, 1, and 2, the UE may determine that the UE has received all UL grants transmitted by the eNB since the UE has detected continuous UGC values without an empty part (without a missing value). Here, if the UE has received 2 UL grants having UGC values of 1 and 2, the UE may determine that the UE has not received a UL grant having a UGC value of 0. Even when the UE has failed to decode some UL grant, there may be no problem in association with UCI piggyback transmission by the UE and UCI reception by the eNB if the decoded UL grants have UGC values which are continuous, starting from 0. For example, in the case in which the method in which UCI is piggybacked on a PUSCH having the lowest carrier index is applied, UCI is piggybacked on a PUSCH of UL CC index 0 both when the UE has received all 3 UL grants and when the UE has received only 2 UL grants and therefore it is possible to reduce ambiguity as to which UL CC carries a PUSCH on which UCI to be detected by the eNB is piggybacked.

On the other hand, we can consider the case in which there are one or more empty parts (i.e., one or more missing values) in an arrangement of UGC values included in a plurality of UL grants decoded by the UE. For example, we can consider the case in which discontinuous UGC values such as 0 and 2 are arranged. In this case, the UE may transmit a PUSCH according to the UL grant and may transmit UCI through a PUCCH in a UL PCC (or UL P-cell) simultaneously with transmission of the PUSCH.

The following is a description of operations of the eNB for receiving UCI when the UE has transmitted the UCI through piggyback on a PUSCH as described above.

As described above, the UE may determine whether or not the UE has failed to detect a UL grant using a UGC value included in the UL grant and may transmit UCI through piggyback on a PUSCH or transmit UCI through a PUCCH of a UL P-cell depending on the determination. Thus, the number of cases in which the eNB can expect UCI to be received from the UE is reduced to 2. One is the case in which UCI is received through a PUCCH of a UL PCC (or UL P-cell) and the other is the case in which UCI is received through piggyback on a PUSCH in a predetermined UL CC (i.e., a UL CC intended by the eNB). The predetermined PUSCH is selected according to the method in which a UL CC in which UCI is piggybacked on a PUSCH is set through a UL grant or the method in which UCI is piggybacked on a PUSCH having the lowest carrier index as described above. Accordingly, it is possible to significantly reduce ambiguity as to UCI reception by the eNB and to reduce the complexity of operation of the eNB.

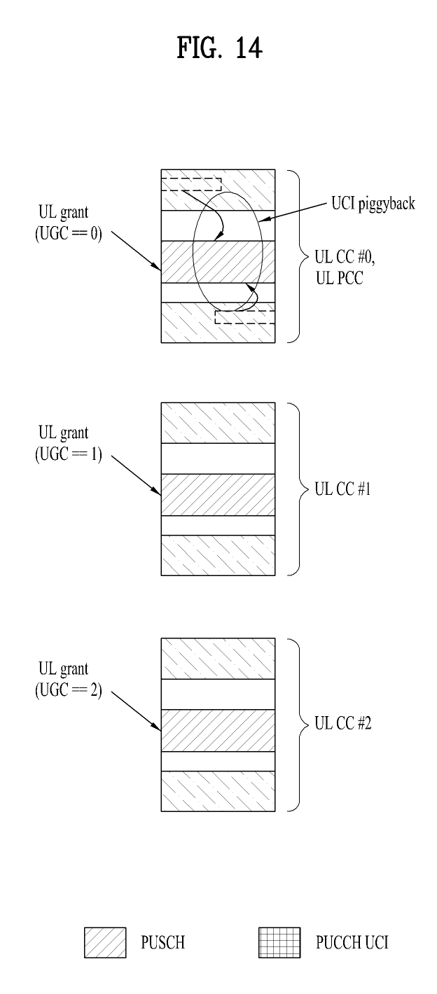

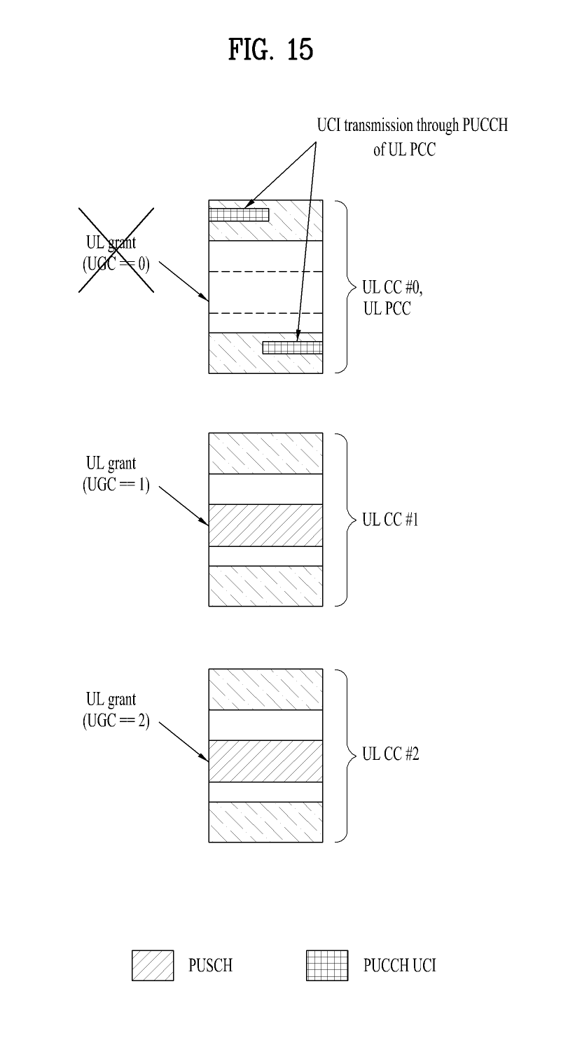

The method of determining a PUSCH on which UCI is piggybacked using a UGC as described above is exemplarily described below using various examples shown in FIGS. 14 to 20. In the examples of FIGS. 14 to 20, it is assumed that 3 uplink carriers (UL CC #0, UL CC #1, and UL CC #2) are assigned to a UE and the UL CC #0 is set as a UL PCC (or UL P-cell). In addition, in the examples of FIGS. 14 to 20, the eNB may transmit UL grants whose UGC values are set to 0, 1, and 2 respectively for the UL CCs and the UE may attempt to detect the UL grants using a blind decoding scheme. Further, in the examples of FIGS. 14 to 20, it is assumed that the method in which a PUSCH having the lowest index is selected as a PUSCH on which UCI is piggybacked when the UE has determined that the UE has detected a UL grant without missing it through a UGC is applied. If the UE has not received any UL grant or if the UE has determined that the UE has missed a UL grant through a UGC, the UE may transmit UCI through a PUCCH of the UL PCC (or UL P-cell).

FIG. 14 illustrates an example in which a UE has received all UL grants transmitted by an eNB. Accordingly, the UE may transmit UCI through piggyback on a PUSCH of UL CC #0 which is the lowest carrier index. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

FIG. 15 illustrates an example in which a UE has missed a UL grant of UL CC #0 among UL grants transmitted by an eNB. In this case, since the UE has detected only UL grants whose UGC values are set to 1 and 2, the UE may determine that the UE has missed a UL grant whose UGC value is set to 0. Thus, the UE may transmit UCI through a PUCCH of UL CC #0 which is the UL PCC. The eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

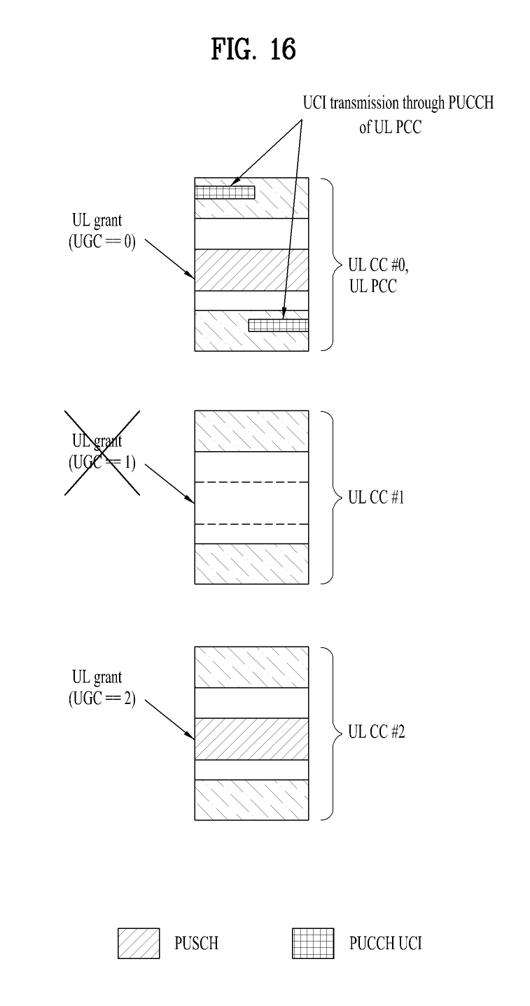

FIG. 16 illustrates an example in which a UE has missed a UL grant of UL CC #1 among UL grants transmitted by an eNB. In this case, since the UE has detected only UL grants whose UGC values are set to 0 and 2, the UE may determine that the UE has missed a UL grant whose UGC value is set to 1. Thus, the UE may transmit UCI through a PUCCH of UL CC #0 which is the UL PCC. The eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

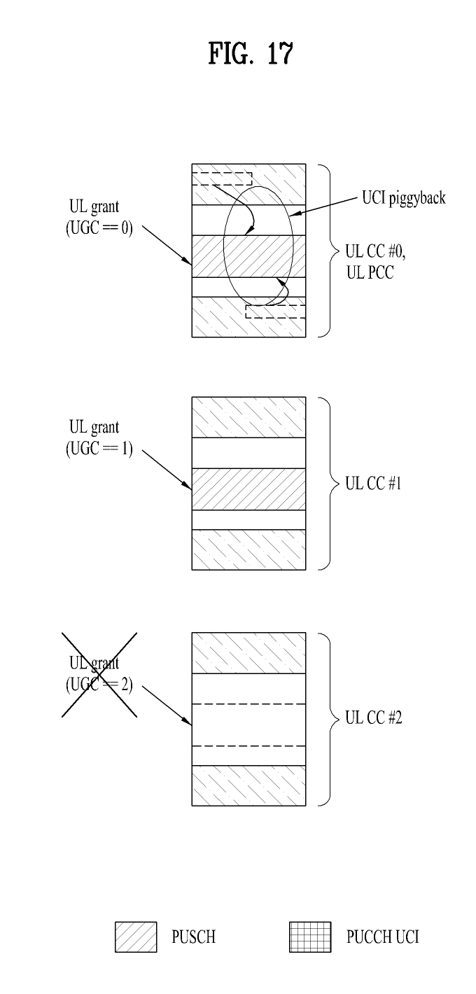

FIG. 17 illustrates an example in which a UE has missed a UL grant of UL CC #2 among UL grants transmitted by an eNB. In this case, since the UE has detected only UL grants whose UGC values are set to 0 and 1, the UE may determine that the eNB has transmitted only 2 UL grants and the UE has decoded all the UL grants transmitted by the eNB. That is, the UE fails to determine that a UL grant whose UGC value is set to 2 is present and the UE has missed the UL grant. However, in this case, there is no ambiguity from the viewpoint of the eNB since UCI is transmitted through piggyback on a PUSCH as intended by the eNB. That is, the UE may transmit UCI through piggyback on a PUSCH of UL CC #0 which is the lowest carrier index. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

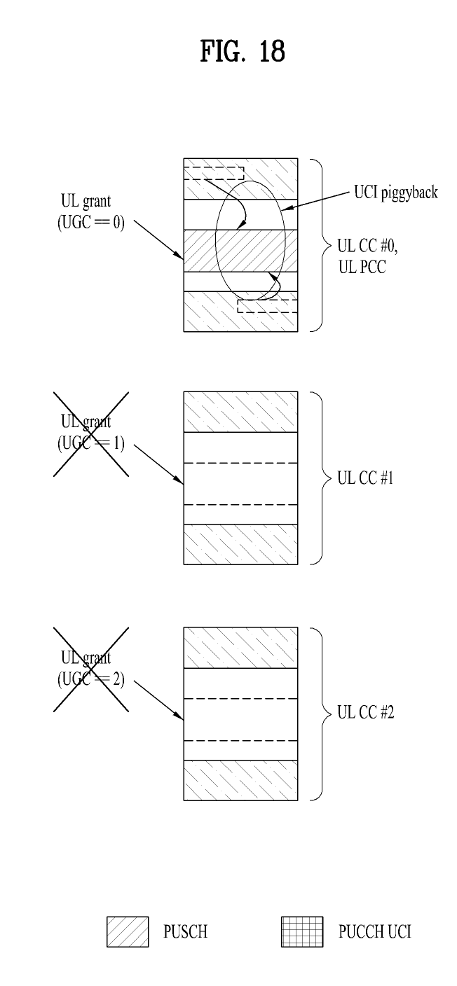

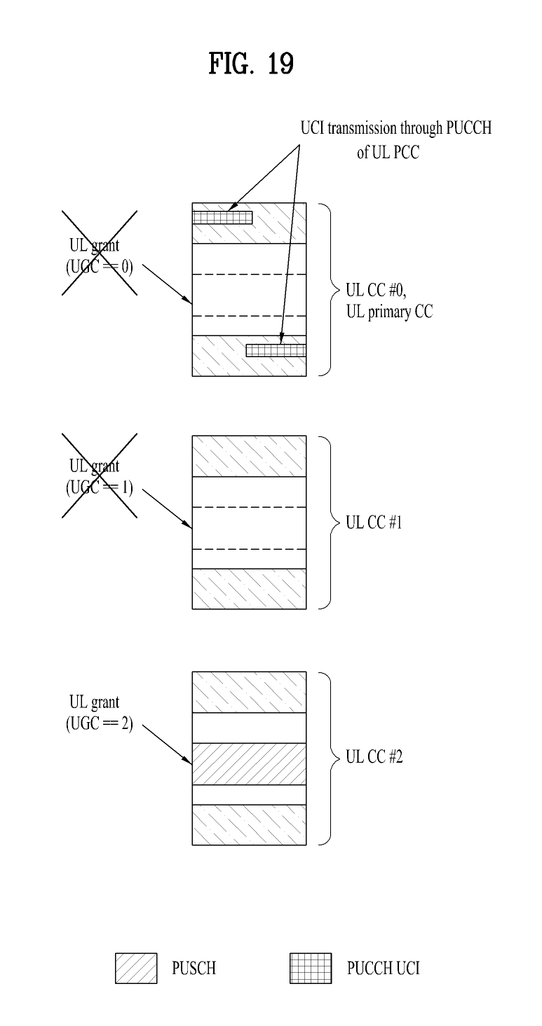

FIG. 18 illustrates an example in which a UE has missed UL grants of UL CC #1 and UL CC #2 among UL grants transmitted by an eNB. In this case, since the UE has detected only a UL grant whose UGC value is set to 0, the UE may determine that the eNB has transmitted only one UL grant and the UE has decoded the UL grant. That is, the UE fails to determine that UL grants whose UGC values are set to 1 and 2 are present and the UE has missed the UL grants. However, in this case, there is no ambiguity from the viewpoint of the eNB since UCI is transmitted through piggyback on a PUSCH as intended by the eNB. That is, the UE may transmit UCI through piggyback on a PUSCH of UL CC #0 which is the lowest carrier index. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

FIG. 19 illustrates an example in which a UE has missed UL grants of UL CC #0 and UL CC #1 among UL grants transmitted by an eNB. In this case, since the UE has detected only a UL grant whose UGC value is set to 2, the UE may determine that the UE has missed UL grants whose UGC values are set to 0 and 1. Thus, the UE may transmit UCI through a PUCCH of UL CC #0 which is the UL PCC. The eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

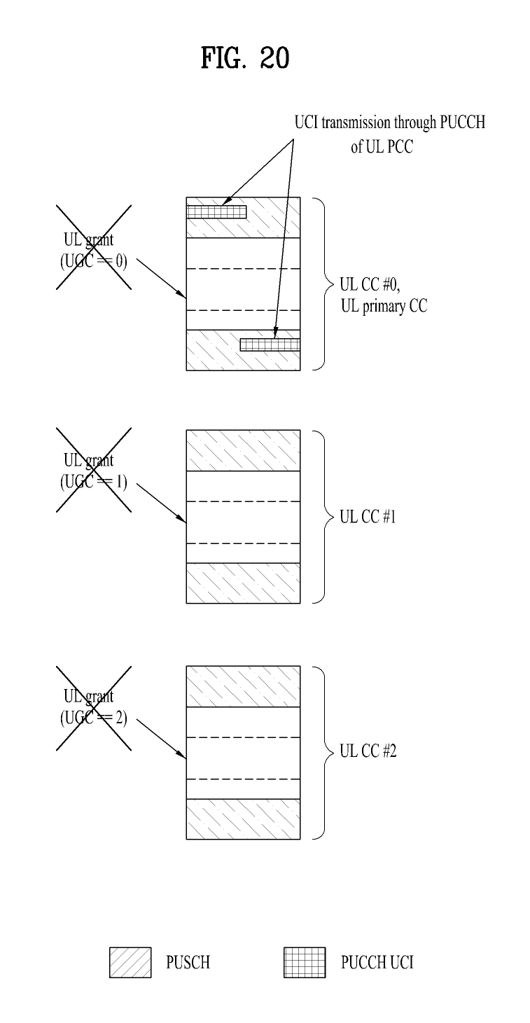

FIG. 20 illustrates an example in which a UE has missed all UL grants transmitted by an eNB. In this case, since the UE has not detected any UL grant, the UE may transmit UCI through a PUCCH of UL CC #0 which is the UL PCC. The eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

As is clearly described in the above examples, the UE may determine whether or not the UE has failed to detect a UL grant through a UGC value included in the UL grant and may then operate to transmit UCI through piggyback on a PUSCH or transmit UCI through a PUCCH of a UL PCC depending on the determination and therefore it is possible to significantly reduce ambiguity as to UCI reception by the eNB and to reduce the complexity of operation of the eNB.

Method 2

This relates to a method in which a PUSCH on which UCI is piggybacked is indicated commonly in one or more UL grants to specify a UCI piggyback operation of a UE, thereby reducing ambiguity as to UCI decoding by an eNB.

According to this method, an eNB may define a UCI Piggybacking Indicator (UPI) field in a UL grant DCI format and a UE may analyze (or identify) the UPI field. The size of the UPI field may be defined according to the number of assignable uplink carriers and may be defined as 2 bits (which enable identification of up to 4 carriers) or 3 bits (which enables identification of up to 8 carriers). The 2-bit or 3-bit UPI field may be defined as an explicit field in a conventional DCI format and may be indicated implicitly through a field defined in a conventional DCI format.

The UPI field may be defined in a UL grant as follows.

UPI fields having one value (i.e., the same value) may be included in one or more UL grants. A PUSCH on which UCI is piggybacked or a UL CC which carries a PUSCH on which UCI is piggybacked may be indicated by the value of the UPI field.

The UPI value may be determined according to the value of a Carrier Indicator Field (CIF) assigned to each UL CC. Alternatively, the UPI value may be determined according to a predetermined UE-specific carrier index or a predetermined cell-specific carrier index. For example, if the UPI value is 1 when 3 UL CCs (CC 0, CC 1, and CC 2) are assigned to a UE, this may indicate that a UL CC, which is to transmit a PUSCH on which UCI is piggybacked, is UL CC #1.

In another example, the lowest UPI value (i.e., 0) may be set for a UL PCC (or UL P-cell) or may be set for the case in which a UL grant for a UL PCC is assigned.

In another example, setting of the UPI value may be performed according to the order of scheduled UL CCs or according to the order of scheduled PUSCHs.

Basically, UPIs included in UL grants for scheduling uplink transmission in an uplink subframe may be set to the same value. However, the present invention is not limited to this example and, in the case in which UPI values are set in a different manner, UPIs included in UL grants may be set to different values. For example, in the case in which a UPI value is set to the sum of the index of a UL CC in which UCI is to be transmitted and the index of a UL CC in which a PUSCH is to be transmitted according to a UL grant, UPI values included in UL grants may be different.

The following is a description of operations of a UE for receiving a UL grant including the UPI field as described above.

(1) The UE may detect one or more UL grants through PDCCH blind decoding and may check a UPI field value included in each UL grant.

(2) When the UE has not decoded any UL grant, the UE may transmit UCI through a PUCCH in a UL PCC (or UL P-cell).

(3) When the UE has decoded one or more UL grants and has acquired UPI values, the UE may operate in the following manner.

When a UL grant PDCCH for scheduling uplink transmission in a UL CC indicated by a UPI value acquired by the UE has been decoded, the UE may perform data/control information multiplexing (i.e., may piggyback UCI on a PUSCH) in the case in which UCI piggyback has been set or has been implicitly assigned.

When a UL grant PDCCH for scheduling uplink transmission in a UL CC indicated by a UPI value acquired by the UE has not been decoded, the UE may transmit a PUSCH according to the UL grant and may transmit a PUSCH in a UL CC other than a UL CC corresponding to the UPI and transmit UCI through a PUCCH in a UL PCC (or UL P-cell) simultaneously with transmission of the PUSCH.

In another example, When a UL grant PDCCH for scheduling uplink transmission in a UL CC indicated by a UPI value acquired by the UE has not been decoded, the UE may drop UCI transmission through a PUCCH and perform PUSCH transmission in a UL CC other than a UL CC corresponding to the UPI or may drop PUSCH transmission in a UL CC other than the UL CC corresponding to the UPI and transmit UCI through a PUCCH.

The following is a description of operations of the eNB for receiving UCI when the UE has transmitted the UCI through piggyback on a PUSCH as described above.

As described above, using a UPI value included in the UL grant, the UE may transmit UCI through piggyback on a PUSCH of a UL CC corresponding to the UPI or may transmit UCI through a PUCCH of a UL PCC (or UL P-cell). Thus, the number of cases in which the eNB can expect UCI to be received from the UE is reduced to 2. One is the case in which UCI is received through a PUCCH of a UL PCC (or UL P-cell) and the other is the case in which UCI is received through piggyback on a PUSCH in a predetermined UL CC (i.e., a UL CC which the eNB has indicated according to the UPI value). Accordingly, it is possible to significantly reduce ambiguity as to UCI reception by the eNB and to reduce the complexity of operation of the eNB.

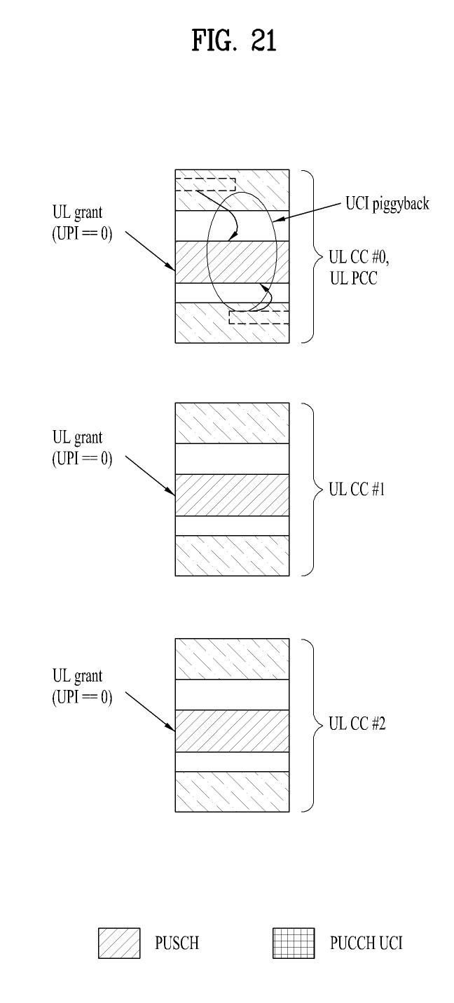

The method of determining a PUSCH on which UCI is piggybacked using a UPI as described above is exemplarily described below using various examples shown in FIGS. 21 to 27. In the examples of FIGS. 21 to 27, it is assumed that 3 uplink carriers (UL CC #0, UL CC #1, and UL CC #2) are assigned to a UE and the UL CC #0 is set as a UL PCC (or UL P-cell). In addition, in the examples of FIGS. 21 to 27, the eNB may transmit one or more UL grants and the UE may attempt to detect the UL grants using a blind decoding scheme. Further, it is assumed in the examples of FIGS. 21 to 27 that UPIs in one or more UL grants are set to the same value and a UPI value of 0 indicates that UCI is piggybacked on a PUSCH of UL CC #0. In addition, in the examples of FIGS. 21 to 27, when a UL grant for scheduling uplink transmission in a UL CC corresponding to the UPI value has been decoded, UCI piggyback transmission may be performed on a PUSCH of the UL CC and, when a UL grant for scheduling uplink transmission in a UL CC corresponding to the UPI value has not been decoded, UCI may be transmitted through a PUCCH of the UL PCC (P-cell). If the UE has not received any UL grant, the UE may transmit UCI through a PUCCH of the UL PCC (or UL P-cell).

FIG. 21 illustrates an example in which a UE has received all UL grants transmitted by an eNB. Accordingly, the UE may transmit UCI through piggyback on a PUSCH of UL CC #0 corresponding to the common UPI value of 0 included in one or more UL grants. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

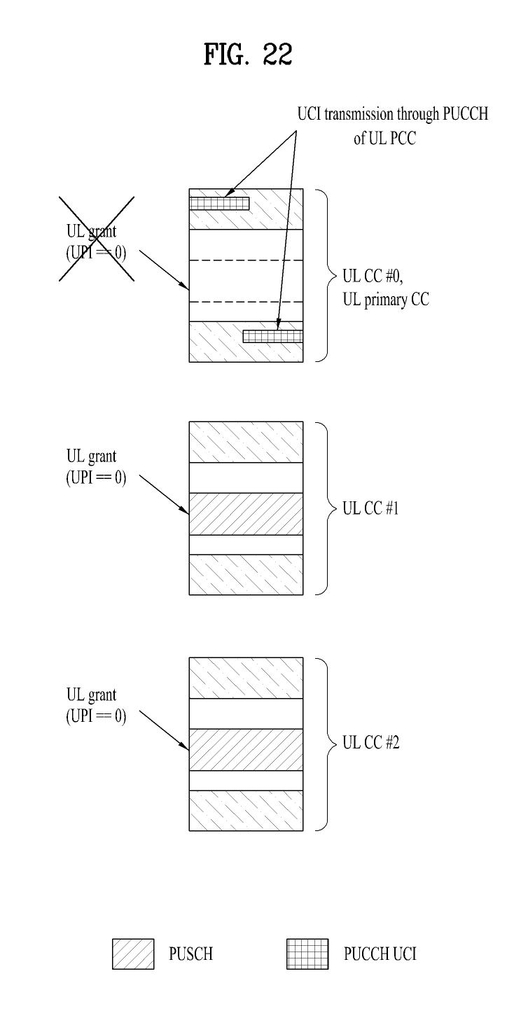

FIG. 22 illustrates an example in which a UE has missed a UL grant of UL CC #0 among UL grants transmitted by an eNB. In this case, since the UE has detected a UL grant of UL CC #1 whose UPI value is set to 0 and a UL grant of UL CC #2 whose UPI value is set to 0, the UE may determine that the UE has not detected a UL grant of UL CC #0 corresponding to the UPI value. Accordingly, the eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

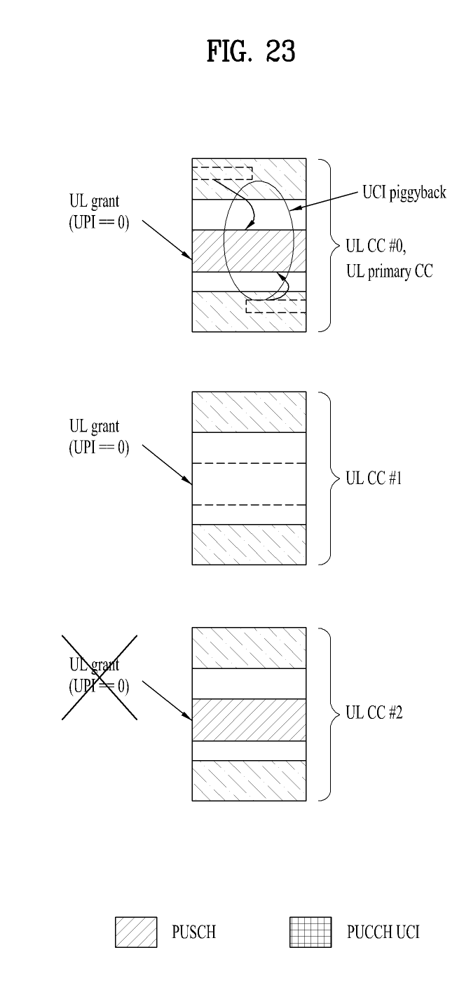

FIG. 23 illustrates an example in which a UE has missed a UL grant of UL CC #1 among UL grants transmitted by an eNB. In this case, since the UE has detected a UL grant of UL CC #0 whose UPI value is set to 0 and a UL grant of UL CC #2 whose UPI value is set to 0, the UE may determine that the UE has detected a UL grant of UL CC #0 corresponding to the UPI value. Accordingly, the UE may transmit UCI through piggyback on a PUSCH of UL CC #0 corresponding to the common UPI value of 0 included in one or more UL grants. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

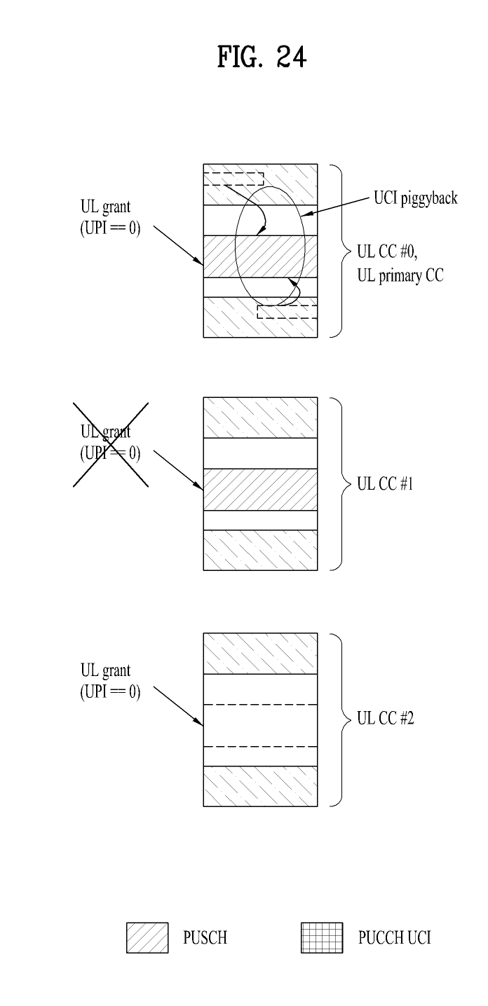

FIG. 24 illustrates an example in which a UE has missed a UL grant of UL CC #2 among UL grants transmitted by an eNB. In this case, since the UE has detected a UL grant of UL CC #0 whose UPI value is set to 0 and a UL grant of UL CC #1 whose UPI value is set to 0, the UE may determine that the UE has detected a UL grant of UL CC #0 corresponding to the UPI value. Accordingly, the UE may transmit UCI through piggyback on a PUSCH of UL CC #0 corresponding to the common UPI value of 0 included in one or more UL grants. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

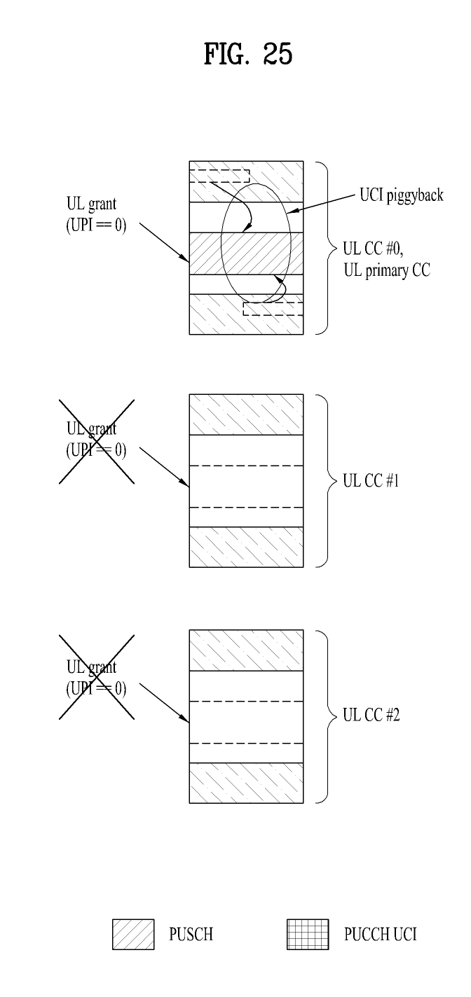

FIG. 25 illustrates an example in which a UE has missed UL grants of UL CC #1 and UL CC #2 among UL grants transmitted by an eNB. In this case, the UE detects only a UL grant of UL CC #0 whose UPI value is set to 0. Accordingly, the UE may transmit UCI through piggyback on a PUSCH of UL CC #0 corresponding to the UPI value of 0 included in the detected UL grant. The eNB may receive the UCI transmitted through piggyback in the PUSCH of UL CC #0 by performing blind decoding on UCI transmission in the PUSCH in the UL CC #0 intended by the eNB or UCI transmission in a PUCCH in the UL PCC (UL CC #0).

Alternatively, in the case in which the eNB has instructed a specific UE or all UEs in a cell to simultaneously transmit a PUCCH and a PUSCH, a UE may transmit, when the UE has data to be transmitted together with UCI in a specific uplink carrier, the UCI through a PUCCH while transmitting the uplink data through a PUSCH. Here, the specific uplink carrier may be a primary carrier or a primary cell.

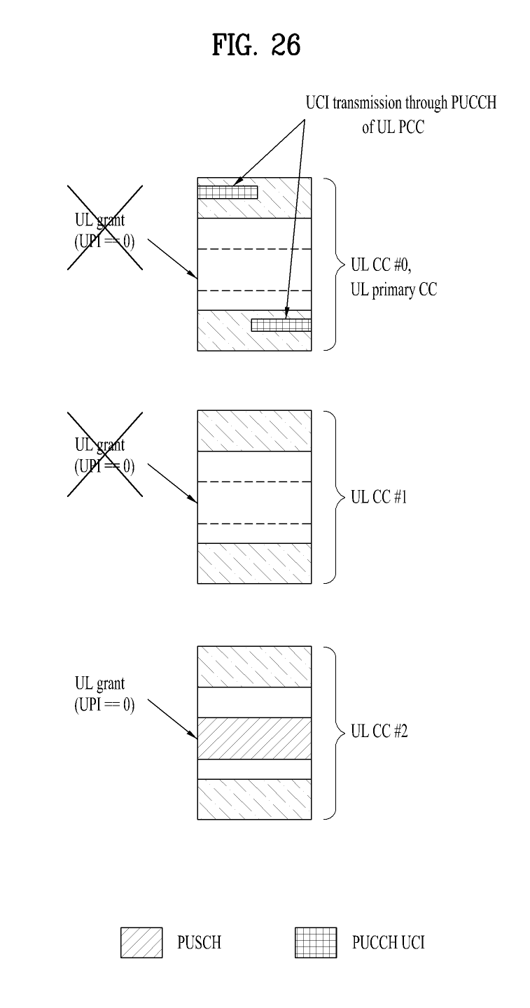

FIG. 26 illustrates an example in which a UE has missed UL grants of UL CC #0 and UL CC #1 among UL grants transmitted by an eNB. In this case, since the UE has detected only a UL grant of UL CC #2 whose UPI value is set to 0, the UE may determine that the UE has not detected a UL grant of UL CC #0 corresponding to the UPI value. Accordingly, the eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

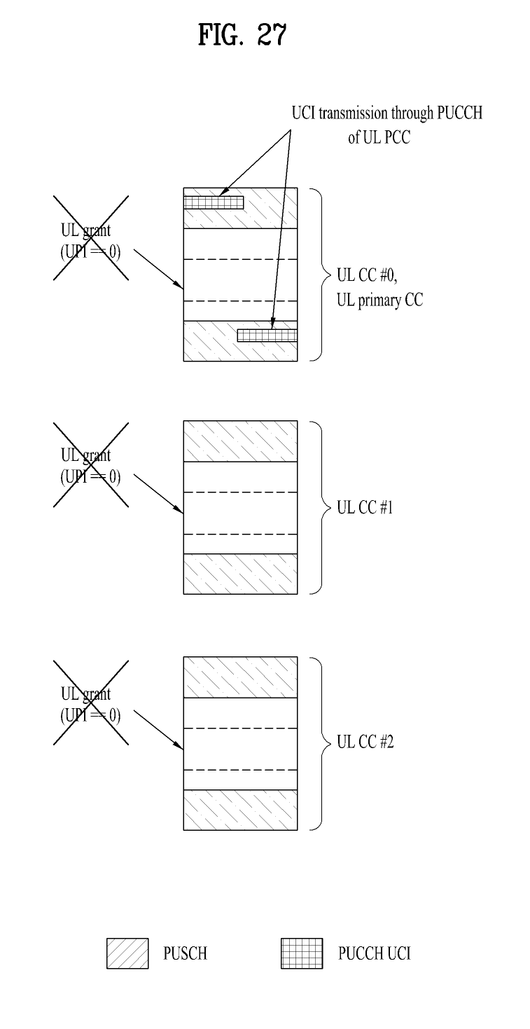

FIG. 27 illustrates an example in which a UE has missed all UL grants transmitted by an eNB. In this case, since the UE has not detected any UL grant, the UE may transmit UCI through a PUCCH of UL CC #0 which is the UL PCC. The eNB may receive the UCI transmitted in the PUCCH of the UL PCC (UL CC #0) by performing blind decoding on UCI transmission in the PUSCH in the UL CC #0 intended by the eNB or UCI transmission in a PUCCH in the UL PCC (UL CC #0).

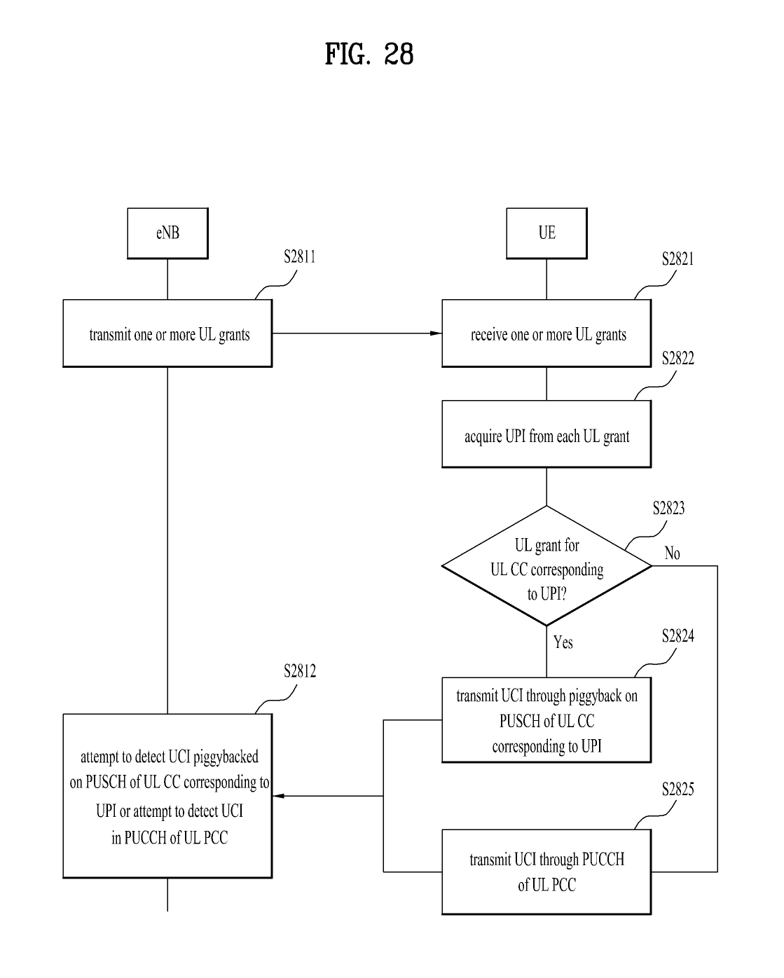

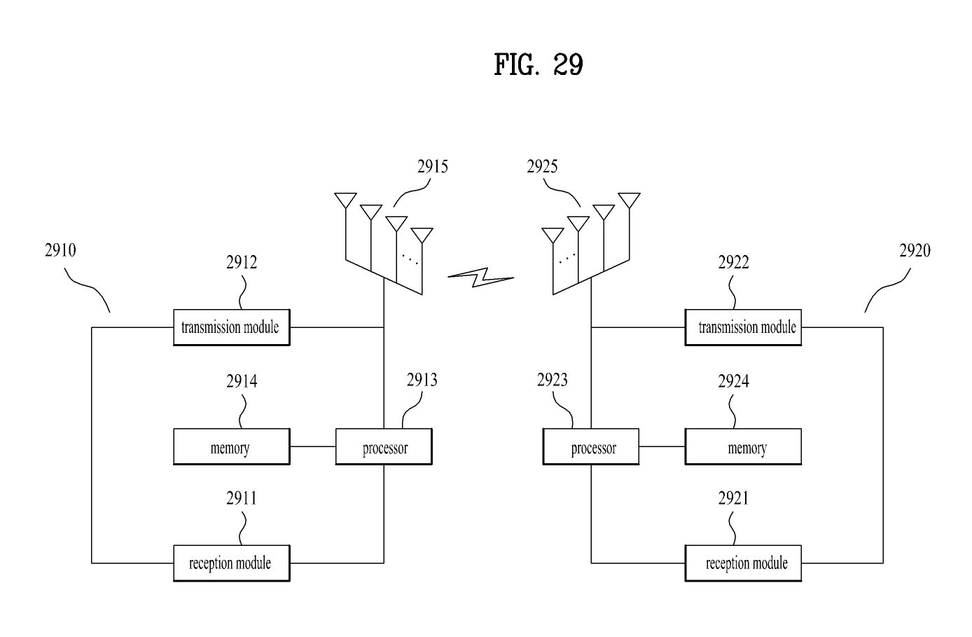

FIG. 28 is a flowchart illustrating a method for transmitting and receiving UCI according to the present invention.

In step S2811, an eNB may transmit one or more UL grants to a UE. Here, each of the one or more UL grants may include control information for scheduling uplink transmission in the same uplink subframe. Each of the one or more UL grants may also include a UCI Piggybacking Indicator (UPI). The UPI is an indicator of an uplink carrier in which UCI is multiplexed and transmitted with uplink data. The UPI may have a size of 2 bits or 3 bits and the value of the UPI may be set to a single common value in one or more UL grants.

In step S2821, the UE may receive one or UL grants transmitted from the eNB. Here, the UE may fail to decode some of the one or more UL grants that the eNB transmits in step S2811. That is, Y≦X when X is the number of one or more UL grants that the eNB transmits in step S2811 and Y is the number of one or more UL grants that the UE detects in step S2821.

In step S2822, the UE may acquire a UPI included in one or more UL grants that has been successfully decoded and thus may determine an uplink carrier in which the eNB has instructed the UE to transmit UCI through piggyback on a PUSCH.

In step S2823, the UE may determine whether or not there is a UL grant for an uplink carrier corresponding to the UPI. If there is a UL grant for an uplink carrier corresponding to the UPI (i.e., if the UL grant received by the UE schedules uplink data transmission in an uplink carrier indicated by the UPI), the UE proceeds to step S2824. If there is no UL grant for an uplink carrier corresponding to the UPI (i.e., if the UL grant received by the UE does not schedule uplink data transmission in an uplink carrier indicated by the UPI), the UE proceeds to step S2825.

In step S2824, the UE may multiplex and transmit UCI with the uplink carrier indicated by the UPI (i.e., may transmit UCI by piggybacking the UCI on the uplink carrier).

In step S2825, the UE may transmit the UCI through a PUCCH of a UL PCC (or UL P-cell).

Even when the UE has missed (i.e., has failed to decode) some of UL grants that the eNB has transmitted to the UE, the number of cases in which the UE transmits the UCI is reduced to 2. That is, the UCI may be transmitted through piggyback on a PUSCH of an uplink carrier indicated by the UPI or may be transmitted through a PUCCH of the UL PCC. Accordingly, the operation of the eNB for attempting to detect UCI in step S2812 may be performed in a simply manner.

In step S2812, assuming that there are two cases in which UCI is transmitted from the UE, the eNB may attempt to detect UCI for each of the two cases. That is, the eNB may attempt to detect UCI which is transmitted through piggyback on a PUSCH of an uplink carrier indicated by the UPI and attempt to detect UCI which is transmitted through a PUCCH of the UL PCC and thus may successfully detect the UCI that the UE has transmitted through one of the two cases.

On the other hand, although not shown in FIG. 28, an uplink Grant Counter (UGC) field may be included in each of one or more UL grants that the eNB transmits in step S2811 as described above with reference to method 1 of the present invention. In this case, the UE may determine whether or not the UE has missed a UL grant based on a UGC included in a UL grant detected by the UE instead of performing step S2823. A UCI transmission method for the UE is determined according to such determination. When the UE has determined that the UE has not missed a UL grant, the UE may transmit UCI by piggybacking the UCI on a PUSCH in a predetermined uplink carrier (which is an uplink carrier set by a UL grant or an uplink carrier determined according to a predetermined rule (for example, an uplink carrier of the lowest index)) instead of performing step S2824 of FIG. 28. When the UE has determined that the UE has missed a UL grant, the UE may transmit UCI through a PUCCH of a UL PCC instead of performing step S2825 of FIG. 28. Accordingly, the eNB may attempt to detect UCI transmission through piggyback on a PUSCH of a predetermined uplink carrier or UCI transmission through a PUCCH of the UL PCC to acquire the UCI instead of performing step S2812 of FIG. 28.

Each of the various embodiments of the present invention described above may be independently applied to the method for transmitting and receiving UCI in a multi-carrier system of the present invention described above with reference to FIG. 28 or 2 or more of the various embodiments of the present invention may be simultaneously applied to the method and redundant descriptions are omitted herein for clear explanation of the present invention.

Although the description of FIG. 28 has been given mainly with reference to the method for transmitting UCI from a UE to an eNB and receiving the UCI from the UE by the eNB as an example, the same principle as described in the present invention may be applied to a method for transmitting UCI from a relay to an eNB and receiving the UCI from the relay by the eNB and a method for transmitting UCI from a UE to a relay and receiving the UCI from the UE by the relay.

FIG. 29 illustrates the configurations of an eNB and a UE according to the present invention.

As shown in FIG. 29, an eNB 2910 according to the present invention may include a reception module 2911, a transmission module 2912, a processor 2913, a memory 2914, and a plurality of antennas 2915. Inclusion of the plurality of antennas 2915 indicates that the eNB supports MIMO transmission and reception. The reception module 2911 may receive various uplink signals, data, and information from UEs. The transmission module 2912 may transmit various downlink signals, data, and information to UEs. The processor 2913 may control overall operation of the eNB 2910.

The eNB 2910 according to an embodiment of the present invention may operate to receive Uplink Control Information (UCI) in a wireless communication system that supports multiple carriers. The processor 2913 of the eNB 2910 may be configured to transmit one or more UL grants to the UE through the transmission module and each of the one or more UL grants may include an indicator (UPI) which indicates an uplink carrier in which UCI is multiplexed and transmitted with uplink data. The processor 2913 may also be configured to attempt to detect the UCI which is multiplexed and transmitted with the uplink data in the uplink carrier indicated by the indicator. The processor 2913 may also be configured to attempt to detect the UCI that is transmitted through a Physical Uplink Control Channel (PUCCH) of a specific uplink carrier (for example, a UL PCC). Here, the UCI may be multiplexed and transmitted with the uplink data in the uplink carrier indicated by the indicator when the UL grant detected by the UE schedules uplink data transmission in the uplink carrier indicated by the indicator. Alternatively, the UCI may be transmitted through a PUCCH of the specific uplink carrier when the UL grant detected by the UE does not schedule uplink data transmission in the uplink carrier indicated by the indicator.

The processor 2913 of the eNB 2910 may also perform a function to arithmetically process information received by the eNB 2910, information to be externally transmitted, or the like and the memory 2914 may store such arithmetically processed information or the like for a certain time and may be replaced with a component such as a buffer (not shown).

Referring to FIG. 29, the UE 2920 according to the present invention may include a reception module 2921, a transmission module 2922, a processor 2923, a memory 2924, and a plurality of antennas 2925. Inclusion of the plurality of antennas 2925 indicates that the UE supports MIMO transmission and reception. The reception module 2921 may receive various downlink signals, data, and information from the eNB. The transmission module 2922 may transmit various uplink signals, data, and information to the eNB. The processor 2923 may control overall operation of the UE 2920.

The UE 2920 according to an embodiment of the present invention may be configured to transmit Uplink Control Information (UCI) in a wireless communication system that supports multiple carriers. The processor 2923 of the UE 2920 may be configured to receive one or more UL grants from the eNB through the reception module. The processor 2923 may also be configured to acquire an indicator (UPI) which indicates an uplink carrier in which UCI is multiplexed and transmitted with uplink data from each of the one or more UL grants. The processor 2923 may also be configured to multiplex and transmit the UCI with the uplink data in the uplink carrier indicated by the indicator through the transmission module when the one or more UL grants schedule uplink data transmission in the uplink carrier indicated by the indicator. Alternatively, the processor 2923 may be configured to transmit the UCI through a Physical Uplink Control Channel (PUCCH) of the specific uplink carrier when the one or more UL grants do not schedule uplink data transmission in the uplink carrier indicated by the indicator.

The processor 2923 of the UE 2920 may also perform a function to arithmetically process information received by the UE 2920, information to be externally transmitted, or the like and the memory 2924 may store such arithmetically processed information or the like for a certain time and may be replaced with a component such as a buffer (not shown).

The eNB and the UE may also be configured to use an uplink Grant Counter (UGC) as described above with reference to method 1 of the present invention. For example, the processor 2913 of the eNB 2910 may be configured to transmit one or more UL grant including a UGC to the UE. The processor 2913 of the eNB 2910 may also be configured to attempt to detect UCI transmission through piggyback on a PUSCH of a predetermined uplink carrier (which is an uplink carrier set by a UL grant or an uplink carrier determined according to a predetermined rule (for example, an uplink carrier of the lowest index)) or UCI transmission through a PUCCH of the UL PCC to acquire the UCI. The processor 2923 of the UE 2920 may be configured to determine whether or not the UE has missed a UL grant based on a UGC included in the UL grant received by the UE. The processor 2923 of the UE 2920 may also be configured to transmit, upon determining that the UE has not missed a UL grant, transmit UCI by piggybacking the UCI on a PUSCH in a predetermined uplink carrier (which is an uplink carrier set by a UL grant or an uplink carrier determined according to a predetermined rule (for example, an uplink carrier of the lowest index)). The processor 2923 of the UE 2920 may also be configured to transmit, upon determining that the UE has missed a UL grant, UCI through a PUCCH of a UL PCC.

The detailed configurations of the eNB and the UE described above may be implemented such that each of the various embodiments of the present invention described above is independently applied or 2 or more thereof are simultaneously applied to the eNB and the UE and redundant descriptions are omitted herein for clear explanation of the present invention.

The description of the eNB 2910 in the description of FIG. 29 may be equally applied to a relay as a downlink transmission entity or an uplink reception entity and the description of the UE 2920 in the description of FIG. 29 may be equally applied to a relay as a downlink reception entity or an uplink transmission entity.

The embodiments of the present invention may be implemented by various means. For example, the embodiments of the present invention may be implemented by hardware, firmware, software, or any combination thereof.

In the case in which the present invention is implemented by hardware, the methods according to the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case in which the present invention is implemented by firmware or software, the methods according to the embodiments of the present invention may be implemented in the form of modules, processes, functions, or the like which perform the features or operations described below. For example, software code can be stored in a memory unit so as to be executed by a processor. The memory unit may be located inside or outside the processor and can communicate data with the processor through a variety of known means.

The detailed description of the exemplary embodiments of the present invention has been given to enable those skilled in the art to implement and practice the present invention. Although the present invention has been described with reference to the exemplary embodiments, those skilled in the art will appreciate that various modifications and variations can be made in the present invention without departing from the spirit or scope of the present invention described in the appended claims. For example, those skilled in the art may combine the structures described in the above embodiments in a variety of ways. Accordingly, the present invention should not be limited to the specific embodiments described herein, but should be accorded the broadest scope consistent with the principles and novel features disclosed herein.

The present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be embraced in the scope of the invention. The invention should not be limited to the specific embodiments described herein, but should be accorded the broadest scope consistent with the principles and novel features disclosed herein. In addition, claims which are not explicitly dependent on each other can be combined to provide an embodiment or new claims can be added through amendment after this application is filed.

### INDUSTRIAL APPLICABILITY

The embodiments of the present invention are applicable to various mobile communication systems.

1. A method for a user equipment to transmit Uplink Control Information (UCI) in a wireless communication system that supports multiple carriers, the method comprising:
receiving at least one uplink grant from a base station;
acquiring an indicator which indicates an uplink carrier in which the UCI is transmitted from each of the at least one uplink grant; and
transmitting the UCI through a Physical Uplink Shared Channel (PUSCH) in the uplink carrier indicated by the indicator when the at least one uplink grant schedules uplink data transmission in the uplink carrier indicated by the indicator.

2. The method according to claim 1, wherein, when data is present in a transmission buffer of the user equipment, the UCI is multiplexed and transmitted with the uplink data through the PUSCH and, when no data is present in the transmission buffer of the user equipment, the UCI is transmitted without data through the PUSCH.

3. The method according to claim 1, wherein the UCI is transmitted through a Physical Uplink Control Channel (PUCCH) of a specific uplink carrier when the at least one uplink grant does not schedule uplink data transmission in the uplink carrier indicated by the indicator.

4. The method according to claim 1, wherein, if the at least one uplink grant schedules uplink data transmission in a specific uplink carrier indicated by the indicator when the base station has instructed that simultaneous transmission of a Physical Uplink Control Channel (PUCCH) and a Physical Uplink Shared Channel (PUSCH) be allowed in a user equipment specific manner or in a cell specific manner, the uplink data is transmitted through a PUSCH in the specific uplink carrier and the UCI is transmitted through a PUCCH in the specific uplink carrier simultaneously with transmission of the uplink data.

5. The method according to claim 3 or 4, wherein the specific uplink carrier is an uplink primary carrier.

6. The method according to claim 1, wherein a value of the indicator is set equal in the at least one uplink grant.

7. The method according to claim 1, wherein the at least one uplink grant includes control information for scheduling uplink data transmission in one uplink subframe.

8. A method for a base station to receive Uplink Control Information (UCI) in a wireless communication system that supports multiple carriers, the method comprising:
transmitting at least one uplink grant, each including an indicator which indicates an uplink carrier in which the UCI is transmitted, to a user equipment; and
attempting to detect the UCI that is transmitted through a Physical Uplink Shared Channel (PUSCH) in the uplink carrier indicated by the indicator,
wherein the UCI is transmitted through a PUSCH in an uplink carrier indicated by the indicator when an uplink grant detected by the user equipment schedules uplink data transmission in the uplink carrier indicated by the indicator.

9. The method according to claim 8, wherein, when data is present in a transmission buffer of the user equipment, the UCI is multiplexed and transmitted with the uplink data through the PUSCH and, when no data is present in the transmission buffer of the user equipment, the UCI is transmitted without data through the PUSCH.

10. The method according to claim 8, further comprising:
attempting to detect the UCI transmitted through a Physical Uplink Control Channel (PUCCH) of a specific uplink carrier,
wherein the UCI is transmitted through the PUCCH of the specific uplink carrier when the uplink grant detected by the user equipment does not schedule uplink data transmission in the uplink carrier indicated by the indicator.

11. The method according to claim 8, further comprising:
attempting to detect the UCI transmitted through a Physical Uplink Control Channel (PUCCH) of a specific uplink carrier,
wherein, if the at least one uplink grant schedules uplink data transmission in the specific uplink carrier indicated by the indicator when the base station has instructed that simultaneous transmission of a Physical Uplink Control Channel (PUCCH) and a Physical Uplink Shared Channel (PUSCH) be allowed in a user equipment specific manner or in a cell specific manner, the uplink data is transmitted through a PUSCH in the specific uplink carrier and the UCI is transmitted through a PUCCH in the specific uplink carrier simultaneously with transmission of the uplink data.

12. The method according to claim 10 or 11, wherein the specific uplink carrier is an uplink primary carrier.

13. The method according to claim 8, wherein a value of the indicator is set equal in the at least one uplink grant.

14. The method according to claim 8, wherein the at least one uplink grant includes control information for scheduling uplink data transmission in one uplink subframe.

15. A user equipment for transmitting Uplink Control Information (UCI) in a wireless communication system that supports multiple carriers, the user equipment comprising:
a reception module for receiving a downlink signal;
a transmission module for transmitting an uplink signal; and
a processor connected to the reception module and the transmission module, the processor controlling operation of the user equipment,
wherein the processor is configured to receive at least one uplink grant from a base station through the reception module, to acquire an indicator which indicates an uplink carrier in which the UCI is transmitted from each of the at least one uplink grant, and to transmit the UCI through a Physical Uplink Shared Channel (PUSCH) in the uplink carrier indicated by the indicator through the transmission module when the at least one uplink grant schedules uplink data transmission in the uplink carrier indicated by the indicator.

16. A base station for receiving Uplink Control Information (UCI) in a wireless communication system that supports multiple carriers, the base station comprising:
a reception module for receiving a downlink signal;
a transmission module for transmitting an uplink signal; and
a processor connected to the reception module and the transmission module, the processor controlling operation of the base station,
wherein the processor is configured to transmit at least one uplink grant, each including an indicator which indicates an uplink carrier in which the UCI is transmitted, to a user equipment through the transmission module and to attempt to detect the UCI that is transmitted through a Physical Uplink Shared Channel (PUSCH) in the uplink carrier indicated by the indicator, and
wherein the UCI is transmitted through a PUSCH in an uplink carrier indicated by the indicator when an uplink grant detected by the user equipment schedules uplink data transmission in the uplink carrier indicated by the indicator.
